(19) United States
(12) Patent Application Publication
(10) Pub. No.: US 2018/0167618 A1
(43) Pub. Date: Jun. 14, 2018

(54) METHOD AND DEVICE FOR PROCESSING VIDEO SIGNAL BY USING GRAPH-BASED TRANSFORM

(71) Applicant: LG Electronics Inc., Seoul (KR)

(72) Inventors: Bumshik LEE, Seoul (KR); Sehoon YEA, Seoul (KR); Moonmo KOO, Seoul (KR)

(21) Appl. No.: 15/579,353

(22) PCT Filed: Jun. 7, 2016
(86) PCT No.: PCT/KR2016/006003

§ 371 Date: Dec. 4, 2017

Related U.S. Application Data
(60) Provisional application No. 62/170,687, filed on Jun. 4, 2015.

(51) Int. Cl. H04N 19/14; H04N 19/176; H04N 19/60; H04N 19/105; H04N 19/124

(52) U.S. Cl. CPC H04N 19/14; H04N 19/176; H04N 19/124; H04N 19/105; H04N 19/60

(57) ABSTRACT

The present invention provides a method for decoding a video signal using a graph-based transform including receiving, from the video signal, a transform index for a target block; deriving a graph-based transform kernel corresponding to the transform index, and the graph-based transform kernel is determined based on boundary information, which represents a property of a signal for a block boundary; and decoding the target block based on the graph-based transform kernel.

### TECHNICAL FIELD

The present invention relates to a method and apparatus for encoding/decoding a video signal using graph-based transform, and more particularly, to a method and apparatus for determining an optimal transform kernel suitable for a property of a residual signal.

### BACKGROUND ART

A compression encoding means a series of signal processing techniques for transmitting digitized information through a communication line or techniques for storing the information in a form that is proper for a storage medium. The media including a picture, an image, an audio, and the like may be the target for the compression encoding, and particularly, the technique of performing the compression encoding targeted to the picture is referred to as a video image compression

The next generation video contents are supposed to have the characteristics of high spatial resolution, high frame rate and high dimensionality of scene representation. In order to process such contents, drastic increase of memory storage, memory access rate and processing power will be resulted.

Accordingly, it is required to design the coding tool for processing the next generation video contents efficiently.

In particular, a graph is a data expression form advantageous for describing inter-pixel relation information, and a graph-based signal processing scheme of processing inter-pixel relation information by expressing it as a graph has been utilized. In the graph-based signal processing, concepts such as sampling, filtering, conversion, and the like, may be generalized using a graph in which each signal sample indicates a vertex and relations of signals are indicated as graph edges having a positive weight.

In the case of such a graph-based signal processing, residual signals may have very different statistical properties depending on a prediction method and a video content. Accordingly, compression efficiency may be increased by using an optimal kernel according to the property of a residual signal.

### DISCLOSURE

### Technical Problem

An object of the present invention is to provide a method of applying a graph-based transform adaptive to a property of a residual signal.

Another object of the present invention is to provide a method for generating an optimal transform kernel based on a graph signal property of a residual block.

A yet another object of the present invention is to provide a method for defining a transform index corresponding to an optimal transform kernel.

Still another object of the present invention is to provide a method for making a Laplacian matrix by adjusting an weight of various neighboring matrixes in a boundary point of a block, a strength, a self-loop weight and the number, and the like so as to be suitable for an input signal that has various properties, and generating an optimal transform kernel using it.

Still another object of the present invention is to provide a method for generating a line graph based on at least one of an edge weight, a number of self-loop and a self-loop weight.

Still another object of the present invention is to provide a method for generating a graph-based transform kernel using various types of line graphs.

Still another object of the present invention is to provide a method for defining a template for a graph-based transform based on at least one of an edge weight, a number of self-loop and a self-loop weight, and signaling it.

### Technical Solution

The present invention provides a method of applying a graph-based transform adaptive to a property of a video signal or a residual signal.

The present invention provides a method for generating an optimal transform kernel based on a graph signal property of a residual block.

The present invention provides a method for defining a transform index corresponding to an optimal transform kernel.

The present invention provides a method for making a laplacian matrix by adjusting an weight of various neighboring matrixes in a boundary point of a block, a strength, a self-loop weight and the number, and the like so as to be suitable for an input signal that has various properties, and generating an optimal transform kernel using it.

The present invention provides a method for generating a line graph based on at least one of an edge weight, a number of self-loop and a self-loop weight.

The present invention provides a method for generating a graph-based transform kernel using various types of line graphs.

The present invention provides a method for defining a template for a graph-based transform based on at least one of an edge weight, a number of self-loop and a self-loop weight, and signaling it.

### Technical Effects

According to the present invention, a flexibility in which a transform can be adaptively applied may be secured, an operation complexity may be decreased, a faster adaptation is available for statistical property which is changed in different video segments with each other, and variability may be provided in performing a transform.

In addition, according to the present invention, more efficient coding may be performed by providing a method for applying an adaptive graph-based transform to a property of a video signal or a residual signal.

In addition, according to the present invention, an overhead in a transform matrix transmission and a transform selection may be significantly decreased by defining a transform index corresponding to an optimal transform kernel.

### DESCRIPTION OF DRAWINGS

FIG. 1 shows a schematic block diagram of an encoder for encoding a video signal, in accordance with one embodiment of the present invention.

FIG. 2 shows a schematic block diagram of a decoder for decoding a video signal, in accordance with one embodiment of the present invention.

FIG. 3 shows examples of graphs used for modeling statistical relationships in 8×8 block within a video frame according to an embodiment to which the present invention is applied.

FIG. 4 shows a graph of two shapes representing weights distribution as an embodiment to which the present invention is applied.

FIG. 5 is a diagram for describing a procedure of obtaining a graph-based transform matrix based on 1-dimensional graph and 2-dimensional graph as an embodiment to which the present invention is applied.

FIG. 6 is a view illustrating 1-dimensional graphs which may become transform bases for applying a separable transform according to an embodiment to which the present invention is applied.

FIG. 7 is a view illustrating a method for applying a different separable transform to each line of a 2-dimension graph according to an embodiment to which the present invention is applied.

FIG. 8 is a schematic block diagram of an encoder which processes a graph-based signal according to an embodiment to which the present invention is applied.

FIG. 9 is a schematic block diagram of a decoder which processes a graph-based signal according to an embodiment to which the present invention is applied.

FIG. 10 is an internal block diagram of a graph-based transform unit according to an embodiment to which the present invention is applied.

FIG. 11 is a flowchart for describing a method for deriving a graph-based transform kernel using a transform index as an embodiment to which the present invention is applied.

FIG. 12 is a flowchart for describing a method for generating an optimal transform kernel according to a property of a video signal or a residual signal as an embodiment to which the present invention is applied.

FIG. 13 is a diagram for describing a transform type (or transform index) according to a number of self-loop, a self-loop weight and an edge weight as an embodiment to which the present invention is applied.

FIGS. 14 to 18 illustrate various examples of line graphs that may be generated based on at least one of a number of self-loop, a self-loop weight and an edge weight as embodiments to which the present invention is applied.

### BEST MODE FOR INVENTION

The present invention provides a method for decoding a video signal using a graph-based transform including receiving, from the video signal, a transform index for a target block; deriving a graph-based transform kernel corresponding to the transform index, and the graph-based transform kernel is determined based on boundary information, which represents a property of a signal for a block boundary; and decoding the target block based on the graph-based transform kernel.

In the present invention, the boundary information includes at least one of an edge weight, a number of self-loop and a self-loop weight.

In the present invention, at least one of the edge weight and the self-loop weight is separately set into a left boundary value and a right boundary value.

In the present invention, the graph-based transform kernel corresponds to one of predefined transform types according to the boundary information.

In the present invention, the graph-based transform kernel is derived for each sub-block according to the transform index, and wherein different transform types with each other are applied to at least two or more sub-blocks.

In the present invention, when the target block is comprised of M or N sub-blocks which are partitioned in a horizontal direction or a vertical direction, wherein the transform index corresponds to each sub-block.

In the present invention, the graph-based transform kernel is a 2 dimensional separable graph-based transform kernel generated based on a combination of a plurality of one dimensional graph-based transforms.

In the present invention, the transform index is received for each of at least one of a coding unit, a prediction unit or a transform unit.

The present invention provides a method for encoding a video signal using a graph-based transform including generating a graph signal according to a property of a differential signal; determining an optimal transform kernel based on the graph signal, wherein the optimal transform kernel is determined based on boundary information, which represents a property of a signal for a block boundary; and performing a transform for the residual signal using the optimal transform kernel.

In the present invention, the method further includes encoding a transform index corresponding to the optimal transform kernel.

The present invention provides an apparatus for decoding a video signal using a graph-based transform including a parsing unit for receiving, from the video signal, a transform index for a target block; and an inverse transform unit for deriving a graph-based transform kernel corresponding to the transform index, and decoding the target block based on the graph-based transform kernel, and the graph-based transform kernel is determined based on boundary information, which represents a property of a signal for a block boundary.

The present invention provides an apparatus for encoding a video signal using a graph-based transform including a graph signal generation unit for generating a graph signal according to a property of a differential signal; a transform matrix determination unit for determining an optimal transform kernel based on the graph signal, and the optimal transform kernel is determined based on boundary information, which represents a property of a signal for a block boundary; and a transform performing unit for performing a transform for the residual signal using the optimal transform kernel.

### MODE FOR INVENTION

Hereinafter, exemplary elements and operations in accordance with embodiments of the present invention are described with reference to the accompanying drawings, however, it is to be noted that the elements and operations of the present invention described with reference to the drawings are provided as only embodiments and the technical spirit and kernel configuration and operation of the present invention are not limited thereto.

Furthermore, terms used in this specification are common terms that are Furthermore, terms used in this specification are common terms that are now widely used, but in special cases, terms randomly selected by the applicant are used. In such a case, the meaning of a corresponding term is clearly described in the detailed description of a corresponding part. Accordingly, it is to be noted that the present invention should not be construed as being based on only the name of a term used in a corresponding description of this specification and that the present invention should be construed by checking even the meaning of a corresponding term.

Furthermore, terms used in this specification are common terms selected to describe the invention, but may be replaced with other terms for more appropriate analysis if such terms having similar meanings are present. For example, a signal, data, a sample, a picture, a frame, and a block may be properly replaced and interpreted in each coding process. Furthermore, partitioning, decomposition, splitting, division may also be properly replaced and interpreted in each coding process.

By applying a linear transform that adaptively modifies the statistical properties of a signal in different parts of a video sequence, compression efficiency may be improved. General statistical methods have been tried such an object, but they bring a restricted result. The present invention introduces a graph-based signal processing technique as a more efficient method for modeling statistical properties of a video signal for video compression.

In order to simplify mathematical analysis and to use the result known from a graph theory, most of applications developed for the graph-based signal processing uses an undirected graph without self-loop (i.e., there is no edge that connects nodes in itself.), and models with non-negative edge only in each graph edge.

Such an approach may be successfully applied for signaling an image of well defined discontinuity, sharp edge or a depth image. The graphs corresponding to N² pixel blocks in an image and video application require transmission overhead for 2N² or 4N² non-negative edge weights, generally. After a graph is defined, the orthogonal transform for coding or prediction may be derived by calculating spectral decomposition of a graph Laplacian matrix. For example, through the spectral decomposition, an eigenvector and an eigen value may be obtained.

The present invention provides a new method for modifying the procedure of calculating a graph-based transform using new generalization of the conventional spectral decomposition. Here, the transform obtained from a graph signal may be defined as Graph-Based Transform (hereinafter, GBT). For example, when the relation information between pixels constructing a TU is represented in a graph, the transform obtained from the graph may be referred to as GBT.

The general form of the spectral decomposition to which the present invention is applied may be obtained based on an additional set of graph edge parameters that have desired properties and graph vertex parameters. Through such an embodiment of the present invention, the transform properties may be well controlled, and the problem of sharp discontinuities of the vectors defining transform may be avoided. Hereinafter, the embodiments to which the present invention will be described in detail.

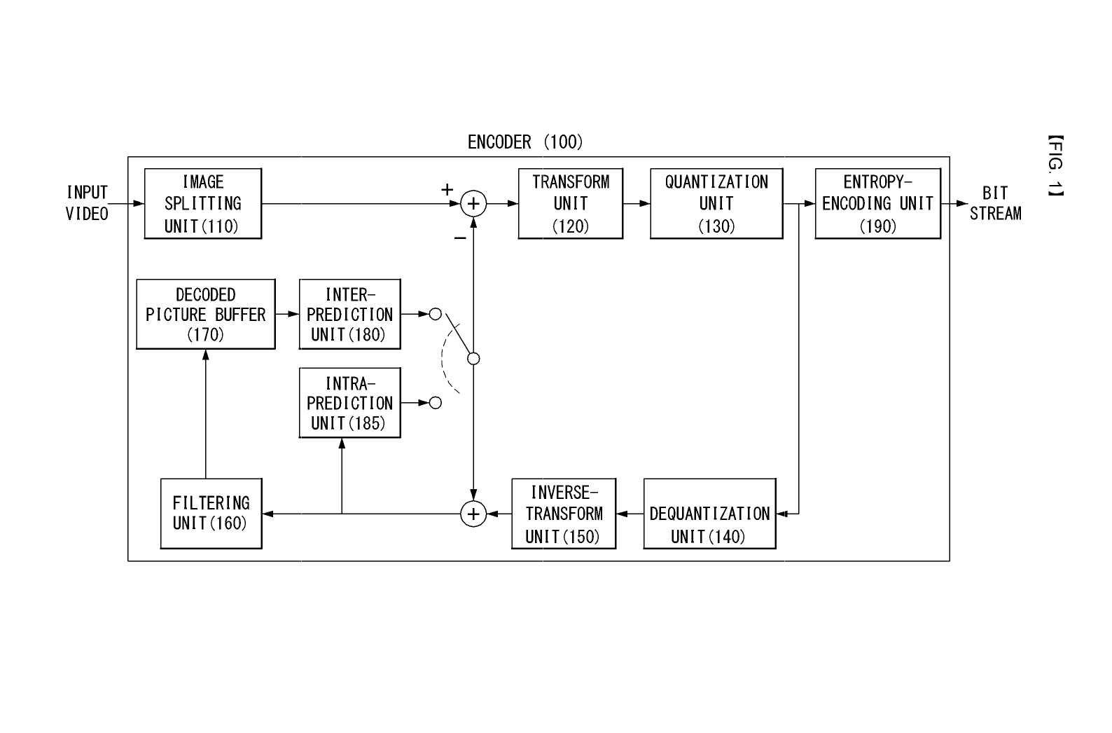

FIG. 1 shows a schematic block diagram of an encoder for encoding a video signal, in accordance with one embodiment of the present invention.

Referring to FIG. 1, an encoder 100 may include an image segmentation unit 110, a transform unit 120, a quantization unit 130, an inverse quantization unit 140, an inverse transform unit 150, a filtering unit 160, a DPB (Decoded Picture Buffer) 170, an inter-prediction unit 180, an intra-prediction unit 185 and an entropy-encoding unit 190.

The image segmentation unit 110 may divide an input image (or, a picture, a frame) input to the encoder 100 into one or more process units. For example, the process unit may be a coding tree unit (CTU), a coding unit (CU), a prediction unit (PU), or a transform unit (TU).

However, the terms are used only for convenience of illustration of the present disclosure. The present invention is not limited to the definitions of the terms. In this specification, for convenience of illustration, the term “coding unit” is employed as a unit used in a process of encoding or decoding a video signal. However, the present invention is not limited thereto. Another process unit may be appropriately selected based on contents of the present disclosure.

The encoder 100 may generate a residual signal by subtracting a prediction signal output from the inter-prediction unit 180 or intra prediction unit 185 from the input image signal. The generated residual signal may be transmitted to the transform unit 120.

The transform unit 120 may apply a transform technique to the residual signal to produce a transform coefficient. The transform process may be applied to a pixel block having the same size of a square, or to a block of a variable size other than a square.

The quantization unit 130 may quantize the transform coefficient and transmits the quantized coefficient to the entropy-encoding unit 190. The entropy-encoding unit 190 may entropy-code the quantized signal and then output the entropy-coded signal as bitstreams.

The quantized signal output from the quantization unit 130 may be used to generate a prediction signal. For example, the quantized signal may be subjected to an inverse quantization and an inverse transform via the inverse quantization unit 140 and the inverse transform unit 150 in the loop respectively to reconstruct a residual signal. The reconstructed residual signal may be added to the prediction signal output from the inter-prediction unit 180 or intra-prediction unit 185 to generate a reconstructed signal.

On the other hand, in the compression process, adjacent blocks may be quantized by different quantization parameters, so that deterioration of the block boundary may occur. This phenomenon is called blocking artifacts. This is one of important factors for evaluating image quality. A filtering process may be performed to reduce such deterioration. Using the filtering process, the blocking deterioration may be eliminated, and, at the same time, an error of a current picture may be reduced, thereby improving the image quality.

The filtering unit 160 may apply filtering to the reconstructed signal and then outputs the filtered reconstructed signal to a reproducing device or the decoded picture buffer 170. The filtered signal transmitted to the decoded picture buffer 170 may be used as a reference picture in the inter-prediction unit 180. In this way, using the filtered picture as the reference picture in the inter-picture prediction mode, not only the picture quality but also the coding efficiency may be improved.

The decoded picture buffer 170 may store the filtered picture for use as the reference picture in the inter-prediction unit 180.

The inter-prediction unit 180 may perform temporal prediction and/or spatial prediction with reference to the reconstructed picture to remove temporal redundancy and/or spatial redundancy. In this case, the reference picture used for the prediction may be a transformed signal obtained via the quantization and inverse quantization on a block basis in the previous encoding/decoding. Thus, this may result in blocking artifacts or ringing artifacts.

Accordingly, in order to solve the performance degradation due to the discontinuity or quantization of the signal, the inter-prediction unit 180 may interpolate signals between pixels on a subpixel basis using a low-pass filter. In this case, the subpixel may mean a virtual pixel generated by applying an interpolation filter. An integer pixel means an actual pixel existing in the reconstructed picture. The interpolation method may include linear interpolation, bi-linear interpolation and Wiener filter, etc.

The interpolation filter may be applied to the reconstructed picture to improve the accuracy of the prediction. For example, the inter-prediction unit 180 may apply the interpolation filter to integer pixels to generate interpolated pixels. The inter-prediction unit 180 may perform prediction using an interpolated block composed of the interpolated pixels as a prediction block.

The intra-prediction unit 185 may predict a current block by referring to samples in the vicinity of a block to be encoded currently. The intra-prediction unit 185 may perform a following procedure to perform intra prediction. First, the intra-prediction unit 185 may prepare reference samples needed to generate a prediction signal. Then, the intra-prediction unit 185 may generate the prediction signal using the prepared reference samples. Thereafter, the intra-prediction unit 185 may encode a prediction mode. At this time, reference samples may be prepared through reference sample padding and/or reference sample filtering. Since the reference samples have undergone the prediction and reconstruction process, a quantization error may exist. Therefore, in order to reduce such errors, a reference sample filtering process may be performed for each prediction mode used for intra-prediction

The prediction signal generated via the inter-prediction unit 180 or the intra-prediction unit 185 may be used to generate the reconstructed signal or used to generate the residual signal.

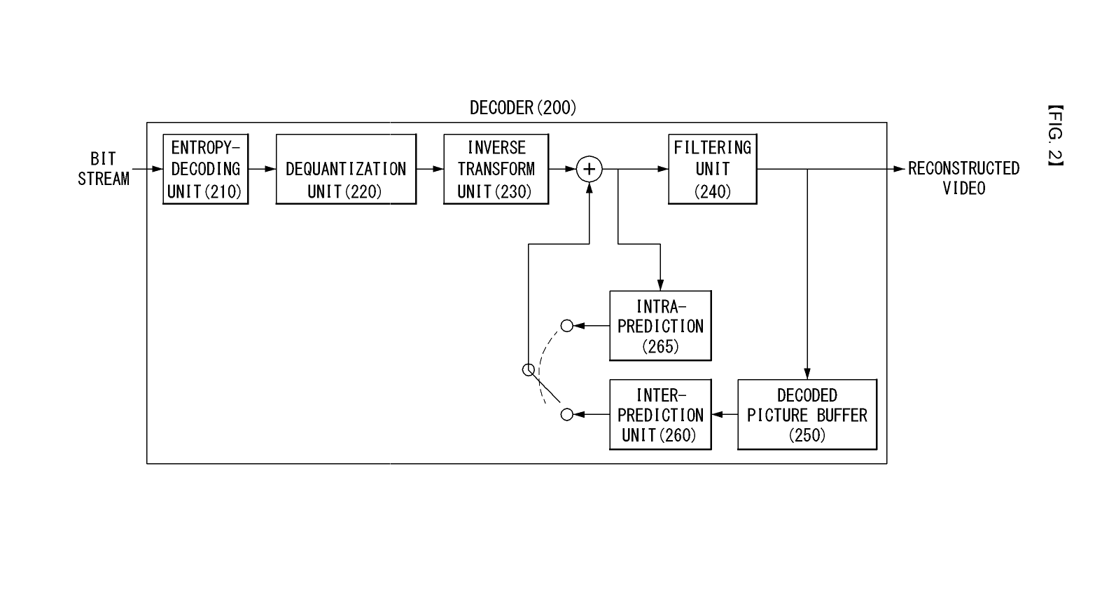

FIG. 2 shows a schematic block diagram of a decoder for decoding a video signal, in accordance with one embodiment of the present invention.

Referring to FIG. 2, a decoder 200 may include a parsing unit (not shown), an entropy-decoding unit 210, an inverse quantization unit 220, an inverse transform unit 230, a filtering unit 240, a decoded picture buffer (DPB) 250, an inter-prediction unit 260 and an intra-prediction unit 265.

A reconstructed video signal output from the decoder 200 may be reproduced using a reproducing device.

The decoder 200 may receive the signal output from the encoder as shown in FIG. 1. The received signal may be entropy-decoded via the entropy-decoding unit 210.

The inverse quantization unit 220 may obtain a transform coefficient from the entropy-decoded signal using quantization step size information. In this case, the obtained transform coefficient may be associated with the operations of the transform unit 120 as described above with reference to FIG. 1.

The inverse transform unit 230 may inverse-transform the transform coefficient to obtain a residual signal.

A reconstructed signal may be generated by adding the obtained residual signal to the prediction signal output from the inter-prediction unit 260 or the intra-prediction unit 265.

The filtering unit 240 may apply filtering to the reconstructed signal and may output the filtered reconstructed signal to the reproducing device or the decoded picture buffer unit 250. The filtered signal transmitted to the decoded picture buffer unit 250 may be used as a reference picture in the inter-prediction unit 260.

Herein, detailed descriptions for the filtering unit 160, the inter-prediction unit 180 and the intra-prediction unit 185 of the encoder 100 may be equally applied to the filtering unit 240, the inter-prediction unit 260 and the intra-prediction unit 265 of the decoder 200 respectively.

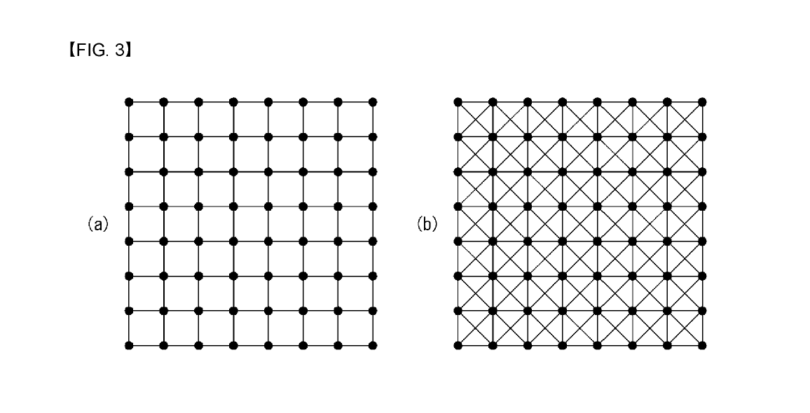

FIG. 3 shows examples of graphs used for modeling statistical relationships in 8×8 block within a video frame according to an embodiment to which the present invention is applied.

The discrete-time signal processing technique has been developed from directly processing and filtering an analogue signal, and accordingly, has been restricted by a few common assumptions such as sampling and processing regularly organized data only.

Basically, the video compression field is based on the same assumption, but has been generalized for a multi-dimensional signal. The signal processing based on a graph representation generalizes the concepts such as sampling, filtering and Fourier transform, uses the graph that represents a vertex by each signal sample, and is started from the conventional approach in which signal relationships are represented by graph edges with positive weights. This completely isolates a signal from its acquisition process, and accordingly, the properties such as sampling rate and sequence are completely replaced by the properties of a graph. Accordingly, the graph representation may be defined by a few specific graph models.

In the present invention, an undirected simple graph and an undirected edge may be used to represent an empirical connection between data values. Here, the undirected simple graph may mean a graph without self-loop or multiple edges.

When the undirected simple graph that has a weight allocated for each edge is referred to as G, the undirected simple graph G may be described with triplet as represented in Equation 1.

G={v,ε,w} [Equation 1]

Here, V represents V numbers of graph vertex set, c represents a graph edge set, and W represents a weight represented as V×V matrix. Here, weight W may be represented as Equation 2 below.

W_{i,j}=W_{j,i}≥0 [Equation 2]

W_{i,j} represents a weight of edge (i, j), and W_{j,i} represents a weight of edge (j, i). When there is no edge connecting vertex (i, j), W_{i,j}=0. For example, in the case of assuming that there is no self-loop, W_{i,i}=0, always.

The representation is partially overlapped for a special case of the undirected simple graphs that have an edge weight. This is because matrix W includes all types of information of the graph. Accordingly, in the present invention, hereinafter, a graph is represented as G(W).

Meanwhile, referring to FIG. 3, the present invention provides two embodiments of graph types that may be used for processing 8×8 pixel blocks in an image or a video. Each pixel is in relation to a graph vertex, and the pixel value becomes the value of the graph vertex.

A graph edge may mean a line connecting graph vertexes. The graph edge is used for representing a certain type of statistical dependency within a signal, and in this case, a positive weigh may represent the sharpness. For example, each vertex may be connected to all of other vertexes, and weight of 0 may be allocated to an edge that connects vertexes not coupled with each other or weakly coupled. However, for simplifying the representation, the edge having the weight of 0 may be completely removed.

In the graph shown in FIG. 3(a), a graph edge may be defined such that each vertex is connected to the nearest 4 adjacent vertexes. However, a block edge may be differently treated. In addition, in the graph shown in FIG. 3(b), it may be defined that each vertex is connected to the nearest 8 adjacent vertexes.

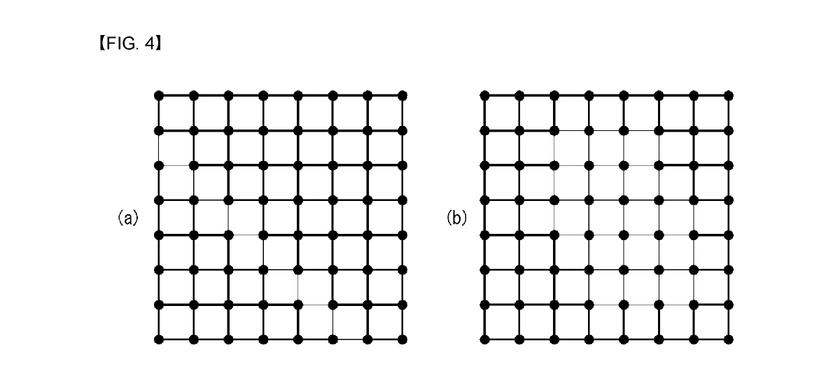

FIG. 4 shows a graph of two shapes representing weights distribution as an embodiment to which the present invention is applied.

The vertex value of a graph is an independent variable based on a signal measurement (normally, modeled as an arbitrary variable), but it is required to select an edge weight in accordance with the property of a part of signal. FIG. 4 shows two exemplary graphs that represent the edge weights of different lines for a graph edge. For example, the bold lines may represent the weight of w=1, and the fine lines may represent the weight of w=0.2.

The graph shown in FIG. 4(a) represents the case of having “weak link” along a straight line, and represents the case of having two types of edge weights only. Here, the “weak link” means having relatively small edge weight.

This is commonly used in a graph-based image processing actually, and such a construction may represent a difference between an edge in an image and a pixel statistics between different sides.

FIG. 4(b) represents a distribution of an edge weight that covers irregular area. The present invention is to provide a method for processing a signal using such a distribution graph of an edge weight.

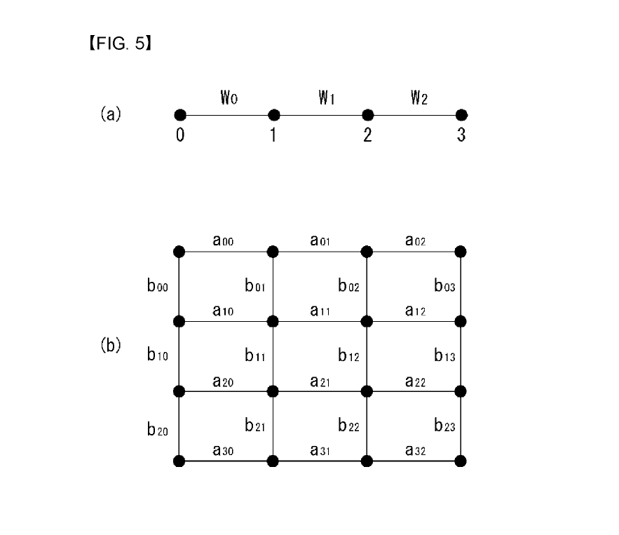

FIG. 5 is a diagram for describing a procedure of obtaining a graph-based transform matrix based on 1-dimensional graph and 2-dimensional graph as an embodiment to which the present invention is applied.

As an embodiment of the present invention, the graph type that may be used for processing a pixel block in an image may be described using FIG. 5. For example, FIG. 5(a) shows 1-dimensional graph that corresponds to each line in the pixel block, and FIG. 5(b) shows 2-dimensional graph that corresponds to the pixel block.

A graph vertex is in relation to each pixel of the pixel block, and a value of the graph vertex may be represented as a pixel value. And, a graph edge may mean a line connecting the graph vertexes. The graph edge is used for representing a certain type of statistical dependency in a signal, and the value representing its sharpness may be referred to as an edge weight.

For example, FIG. 5(a) shows a 1-dimensional graph, 0, 1, 2 and 3 represents the position of each vertex, and w₀, w₁ and w₂ represent the edge weight between vertexes. FIG. 5(b) shows a 2-dimensional graph, and aᵢⱼ (i=0, 1, 2, 3,j=0, 1, 2) and bₖₗ (k=0, 1, 2,l=0, 1, 2, 3) represent the edge weight between vertexes.

Each vertex may be connected to all of other vertexes, and weight of 0 may be allocated to an edge that connects vertexes not coupled with each other or weakly coupled. However, for simplifying the representation, the edge having the weight of 0 may be completely removed.

The relationship information between pixels may be represented as whether there is an edge between pixels and an edge weight when each pixel is mapped to a vertex of a graph.

In this case, GBT may be obtained through the following procedures. For example, an encoder or a decoder may obtain graph information from a target block of a video signal. From the obtained graph information, Laplacian matrix L may be obtained as represented in Equation 3 below.

L=D−A [Equation 3]

In Equation 3 above, D represents a degree matrix. For example, the degree matrix may mean a diagonal matrix including the information of a degree of each vertex. A represents an adjacency matrix that represents the interconnection (for example, edge) with an adjacent pixel by a weight.

And, with respect to the Laplacian matrix L, a GBT kernel may be obtained by performing an eigen decomposition as represented in Equation 4 below.

L=U∧U^{T} [Equation 4]

In Equation 4 above, L means a Laplacian matrix L, U means an eigen matrix, and U^{T} means a transposed matrix of U. In Equation 4, the eigen matrix U may provide a graph-based Fourier transform specialized for a signal suitable for the corresponding model. For example, the eigen matrix U that satisfies Equation 4 may mean a GBT kernel.

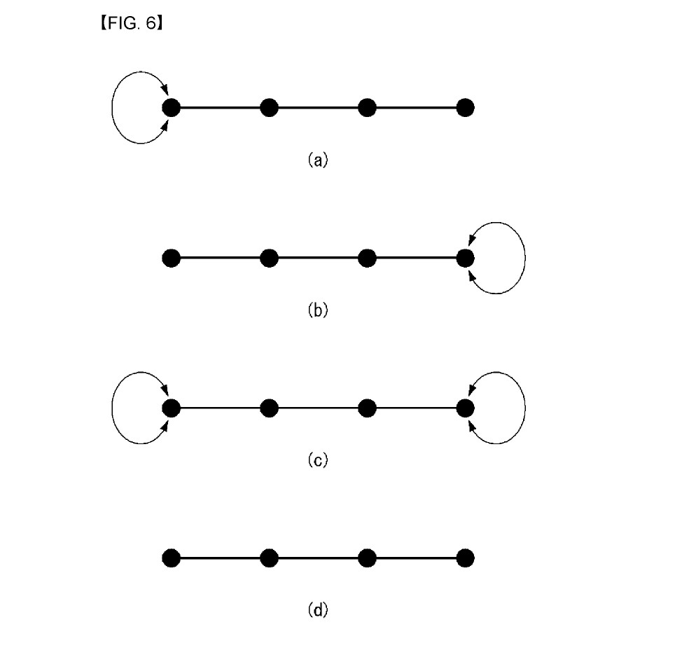

FIG. 6 is a view illustrating 1-dimensional (1D) graphs which may become transform bases for applying a separable transform according to an embodiment to which the present invention is applied.

Embodiments regarding 1D graphs which may become a base for one line may be described as follows.

In a first embodiment, correlation regarding one pixel pair is so small that a weight value of a corresponding edge may be set to be small. For example, a pixel pair including a block boundary may have relatively small correlation, so a small edge weight may be set for a graph edge including a block boundary.

In a second embodiment, a self-loop may be present or not at both ends, or self-loop may be present only at one end. For example, FIGS. 6(a) and 6(b) illustrates the case where the self-loop is present only at one of both ends, FIG. 6(c) illustrates the case where the self-loop is present at both ends of the graph, and FIG. 6(d) illustrates the case where the self-loop is not present at both ends of the graph. Here, the self-loop, representing dependency with an adjacent vertex, may refer to self-weight, for example. That is, a weight may be further given to a portion where the self-loop is present.

In another embodiment of the present invention, an extra 1D separable transform set may be defined according to TU sizes. In the case of non-separable transform, transform coefficient data is increased to O(N⁴) as a TU size is increased, but in the case of the separable transform, the transform coefficient data is increased to O(N²). Thus, the following configuration may be formed by combining several 1D separable transforms forming a base.

For example, as a 1D separable transform template, a template in which the self-loop is present on the left as illustrated in FIG. 6(a), a template in which the self-loop is present on the right as illustrated in FIG. 6(b), a template in which the self-loop is present at both ends as illustrated in FIG. 6(c), and a template in which the self-loop is not present on both sides as illustrated in FIG. 6(d), may be provided. When these templates are all available, the four cases may be possible in rows and columns, and thus, template indices for a total of 16 combinations may be defined.

In another embodiment, in case where a partition boundary or an object boundary is present in the middle of a TU, a template index may be signaled and a separate template in which a small weight value is additionally given only to an edge corresponding to a boundary may be applied instead.

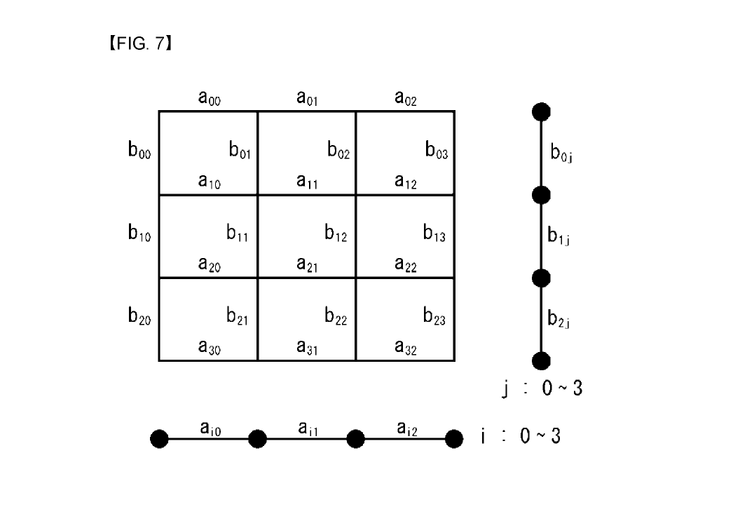

FIG. 7 is a view illustrating a method for applying a different separable transform to each line of a 2-dimensional (2D) graph according to an embodiment to which the present invention is applied.

FIG. 7 illustrates 2D graph corresponding to a pixel block, in which a graph vertex is associated with each pixel of the pixel block, and a value of the graph vertex may be expressed as a pixel value. Here, the line connecting the graph vertices refers to a graph edge. As discussed above, the graph edge is used to indicate statistical dependency in a certain form within a signal, and a value indicating strength thereof may be called an edge weight. For example, referring to FIG. 7, a 2D graph is illustrated in which aᵢⱼ (i=0, 1, 2, 3,j=0, 1, 2), bₖₗ (k=0, 1, 2,l=0, 1, 2, 3) indicate an edge weight between vertices.

In an embodiment to which the present invention is applied, in the case of a 2D graph connecting graph edges only for pixels neighboring in a right angle direction (which may also be called a 4-connected graph), 2D NSGBT (non-separable GBT) may be applied but a 1D SGBT (separable GBT) may be applied to a row direction and a column direction.

For example, since each vertex of the 2D graph of FIG. 7 has a maximum of four neighboring vertices, the graph may be a 4-connected graph, and here, a 2D NSGBT (non-separable GBT) kernel may be generated and applied by using an edge weight (aᵢⱼ, bₖₗ) of each side.

In a specific example, in the row direction, 1D SGBT (separable GBT) for the graph including edge weights of aᵢ₀, aᵢ₁, aᵢ₂ of an ith row is applied to each column, and regarding each column, 1D SGBT (separable GBT) regarding a graph including edge weights of b₀ⱼ, b₁ⱼ, b₂ⱼ of a jth column may be applied to each row.

In another example, in the case of an arbitrary 4-connected graph, different 1D SGBT (separable GBT) may be applied to each line (in both a horizontal direction and a vertical direction). For example, in case where combinations of edge weights for each of column and row are different in FIG. 7, 1D SGBT for each combination may be applied.

Meanwhile, in case where a GBT template set for a N×N TU includes M number of 4-connected graphs, a total of M number of N²×N² transform matrices should be prepared, increasing a memory demand for storing the transform matrices. Thus, if one 4-connected graph can be combined to at least one 1D graph element so as to be configured, only transform for the at least one 1D graph element is required, and thus, a memory amount for storing the transform matrices may be reduced.

In an embodiment of the present invention, various 4-connected 2D graphs may be generated by a limited number of 1D graph elements, whereby a GBT template set appropriate for each mode combination may be customized. Although a total number of GBT templates is increased, the number of 1D transforms forming the base may remain as is, and thus, a required amount of memory may be minimized. For example, combinations of a limited number of (aᵢ₀, aᵢ₁, aᵢ₂) and (b₀ⱼ, b₁ⱼ, b₂ⱼ) may be prepared and appropriately connected in units of 1D graphs for each combination to generate one 4-connected 2D graph.

For example, regarding a current coding block, if graph edge information, partition information, inter-pixel correlation information, and the like, can be received from a bit stream or derived from surrounding information, combinations of 1D transforms may be customized using these information.

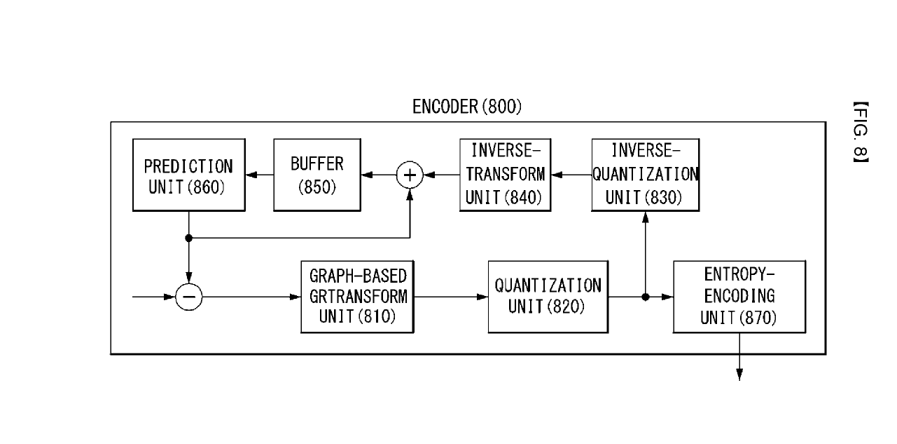

FIG. 8 is a schematic block diagram of an encoder which processes a graph-based signal according to an embodiment to which the present invention is applied.

Referring to FIG. 8, an encoder 800 to which the present invention is applied includes a graph-based transform unit 810, a quantization unit 820, a transform-quantization unit 830, an inverse-transform unit 840, a buffer 850, a prediction unit 860, and an entropy-encoding unit 870.

The encoder 800 receives a video signal and subtracts a predicted signal output from the prediction unit 860 from the video signal to generate a prediction error. The generated prediction error is transmitted to the graph-based transform unit 810, and the graph-based transform unit 810 generates a transform coefficient by applying a transform scheme to the prediction error.

In another embodiment to which the present invention is applied, the graph-based transform unit 810 may compare an obtained graph-based transform matrix with the transform matrix obtained from the transform unit 120 of FIG. 1 and select a more appropriate transform matrix.

The quantization unit 820 quantizes the generated transform coefficient and transmits the quantized coefficient to the entropy-encoding unit 820.

The entropy-encoding unit 820 performs entropy encoding on the quantized signal and outputs an entropy-coded signal.

The quantized signal output from the quantization unit 820 may be used to generate a predicted signal. For example, the inverse-quantization unit 830 within the loop of the encoder 800 and the inverse-transform unit 840 may perform inverse-quantization and inverse-transform on the quantized signal such that the quantized signal may be reconstructed to a prediction error. The reconstructed signal may be generated by adding the reconstructed prediction error to the predicted signal output from the prediction unit 860.

The buffer 850 stores a reconstructed signal for a future reference of the prediction unit 860.

The prediction unit 860 may generate a predicted signal using a signal which was previously reconstructed and stored in the buffer 850. The generated predicted signal is subtracted from the original video signal to generate a residual signal, and the residual signal is transmitted to the graph-based transform unit 810.

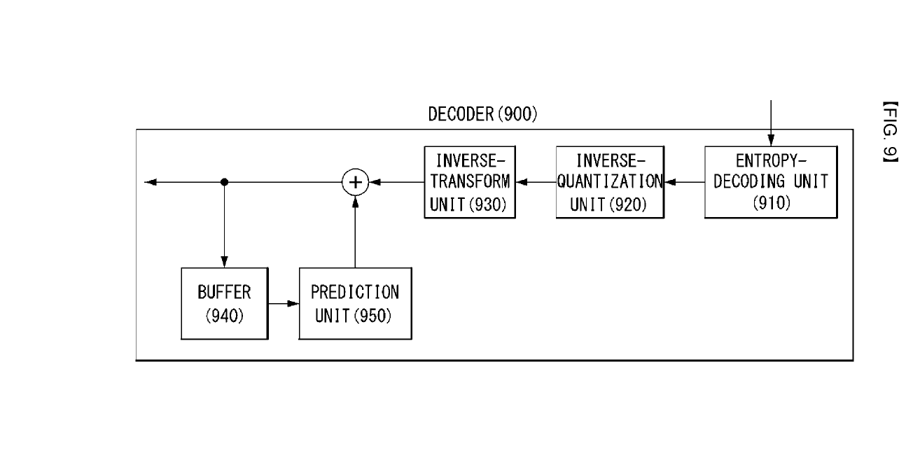

FIG. 9 is a schematic block diagram of a decoder which processes a graph-based signal according to an embodiment to which the present invention is applied.

A decoder 900 of FIG. 9 receives a signal output from the encoder 800 of FIG. 8.

An entropy decoding unit 910 performs entropy-decoding on a received signal. The inverse-quantization unit 920 obtains a transform coefficient from the entropy-decoded signal based on a quantization step size.

The inverse-transform unit 930 performs inverse-transform on a transform coefficient to obtain a residual signal. Here, the inverse-transform may refer to inverse-transform for graph-based transform obtained from the encoder 800.

The obtained residual signal may be added to the predicted signal output from the prediction unit 950 to generate a reconstructed signal.

The buffer 940 may store the reconstructed signal for future reference of the prediction unit 950.

The prediction unit 950 may generate a predicted signal based on a signal which was previously reconstructed and stored in the buffer 940.

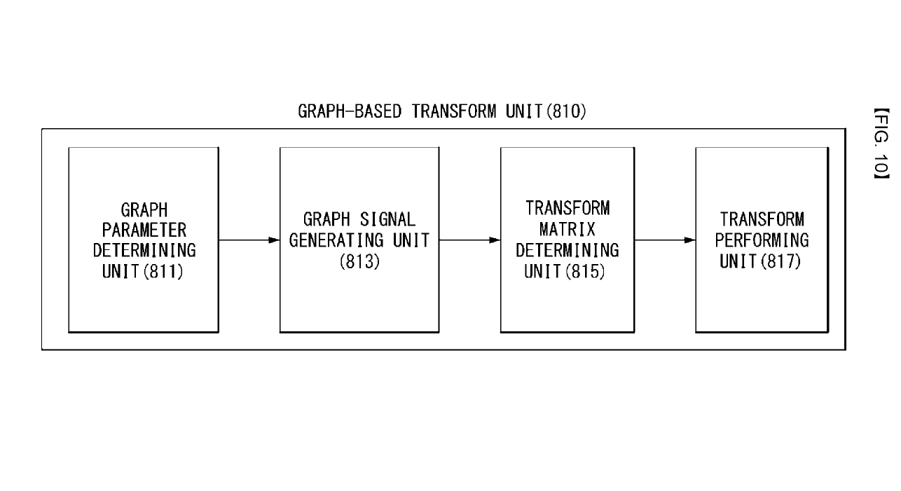

FIG. 10 is an internal block diagram of a graph-based transform unit according to an embodiment to which the present invention is applied.

Referring to FIG. 10, the graph-based transform unit 810 may include a graph parameter determining unit 811, a graph signal generating unit 813, a transform matrix determining unit 815, and a transform performing unit 817.

The graph parameter determining unit 811 may extract a graph parameter of a graph corresponding to a target unit of a video signal or a residual signal. For example, the graph parameter may include at least one of a vertex parameter and an edge parameter. The vertex parameter may include at least one of a vertex position and the number of vertices, and the edge parameter may include at least one of an edge weight value and the number of edge weights. Also, the graph parameter may be defined to a predetermined number of sets.

According to an embodiment of the present invention, a graph parameter extracted from the graph parameter determining unit 811 may be expressed as a generalized form.

The graph signal generating unit 813 may generate a graph signal based on a graph parameter extracted from the graph parameter determining unit 811. Here, the graph signal may include a line graph to which a weight is applied or a weight is not applied. The line graph may be generated for each of a row or column of a target block.

The transform matrix determining unit 815 may determine a transform matrix appropriate for the graph signal. For example, the transform matrix may be determined based on rate distortion (RD) performance. Also, in this disclosure, the transform matrix may be replaced with an expression of transform or a transform kernel so as to be used.

In an embodiment of the present invention, the transform matrix may be a value already determined in the encoder or the decoder, and here, the transform matrix determining unit 815 may be derived from a place where the transform matrix appropriate for the graph signal is stored.

In another embodiment of the present invention, the transform matrix determining unit 815 may generate a 1D transform kernel for a line graph, and generate a 2D separable graph-based transform kernel by combining two of 1D transform kernels. The transform matrix determining unit 815 may determine a transform kernel appropriate for the graph signal among the 2D separable graph-based transform kernels based on the RD performance.

The transform performing unit 817 may perform transform using the transform matrix obtained from the transform matrix determining unit 815.

In this disclosure, functions are sub-divided and described to describe a process of performing graph-based transform, but the present invention is not limited thereto. For example, the graph-based transform unit 810 may include a graph signal generating unit and a transform unit, and here, a function of the graph parameter determining unit 811 may be performed in the graph signal generating unit, and functions of the transform matrix determining unit 815 and the transform performing unit 817 may be performed in the transform unit. Also, a function of the transform unit may be divided into a transform matrix determining unit and a transform performing unit.

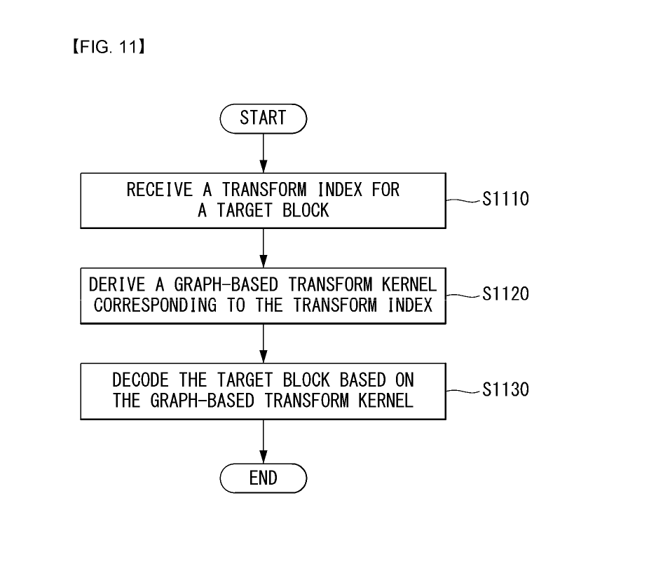

FIG. 11 is a flowchart for describing a method for deriving a graph-based transform kernel using a transform index as an embodiment to which the present invention is applied.

First, a decoder may receive a transform index for a target block from a video signal (S1110). Here, the transform index represents a graph-based transform that is going to be applied to the target block. Step S1110 may be performed in a parsing unit in the decoder.

As an embodiment of the present invention, when the target block includes M or N sub-blocks which are partitioned in a horizontal direction or a vertical direction, the transform index corresponds to each sub-block.

As an embodiment of the present invention, the transform index may be received for each of at least one of a coding unit, a prediction unit or a transform unit.

The decoder may derive a graph-based transform kernel corresponding to the transform index (S1120). Here, the graph-based transform kernel may be generated based on at least one of boundary information, a prediction mode or a size of transform unit.

The boundary information means information for representing a property of a signal for a block boundary, and for example, the boundary information may include at least one of an edge weight, a number of self-loop and a self-loop weight.

The edge weight may be separately set into an edge weight in a left boundary and an edge weight in a right boundary, and the self-loop weight may also be separately set into a self-loop weight in a left boundary and a self-loop weight in a right boundary. In addition, the edge weight may have a directional graph (hereinafter, referred to as ‘digraph’) of which weight is different in a boundary.

The edge weight or the self-loop weight may be represented as three values including a strong weight, no weight and a weak weight. For example, the strong weight may be represented as 2, the no weight may be represented as 1, and the weak weight may be represented as 0. However, the present invention is not limited thereto, but the weight value may be represented as at least one value.

As another embodiment of the present invention, the graph-based transform kernel may be derived for each sub-block according to the transform index, and different transform types with each other may be applied to at least two or more sub-blocks. For example, the different transform types with each other may include at least two of DCT, DST, ADST and RADST.

As an embodiment of the present invention, the graph-based transform kernel may be a two-dimensional separable graph-based transform kernel generated based on a combination of a plurality of one dimensional graph-based transforms.

As an embodiment of the present invention, the graph-based transform kernel may be predefined for each of columns and rows. In this case, an encoder or a decoder may know the graph-based transform kernel in advance, for example, may store it as a table.

Meanwhile, the decoder may decode the target block based on the graph-based transform kernel (S1130).

Steps S1120 to S1130 may be performed in an inverse transform unit in the decoder.

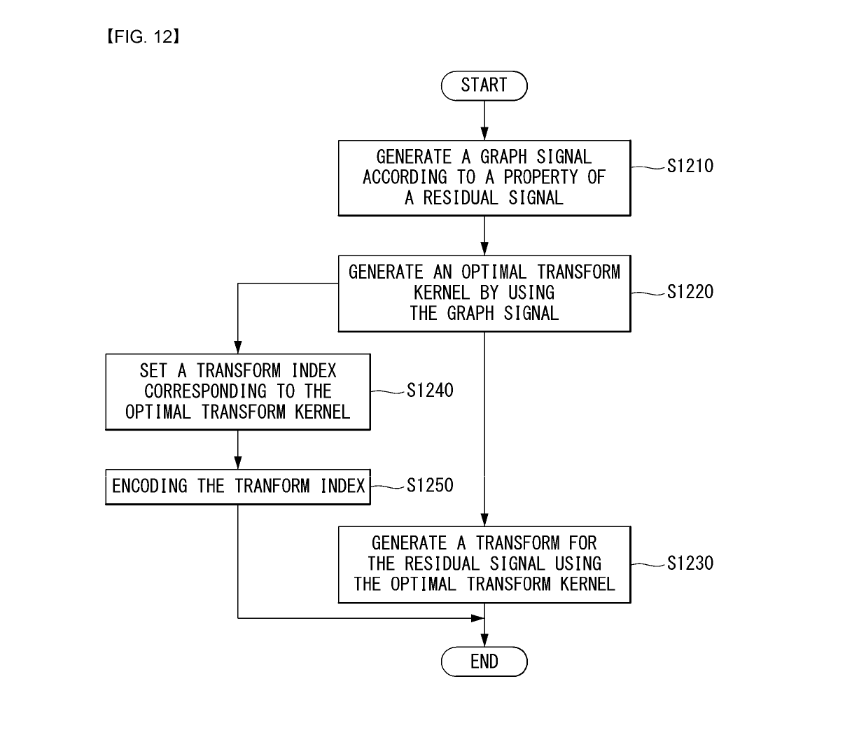

FIG. 12 is a flowchart for describing a method for generating an optimal transform kernel according to a property of a video signal or a residual signal as an embodiment to which the present invention is applied.

In an embodiment of the present invention, an encoder may generate or design a line graph. The encoder may generate a 1D graph-based transform (GBT) associated with the line graph, and in this case, the 1D GBT may be generated by using a generalized Laplacian operator.

Here, assuming that there are an adjacent matrix A and a graph G(A) defined thereof, the Laplacian matrix L may be obtained through Equation 5 below.

L=D−A+S [Equation 5]

In Equation 5 above, D represents a degree matrix, and for example, the degree matrix may mean a diagonal matrix that includes information of degree of each vertex. A represents an adjacency matrix that represents a connection relation (e.g., an edge) with an adjacent pixel as a weight. S represents a diagonal matrix that represents a self-loop in the nodes in G.

In addition, for the Laplacian matrix L, an optimal transform kernel can be obtained by performing an eigen decomposition as represented in Equation 6 below.

L=U∧U^{T} [Equation 6]

In Equation 6 above, L means a Laplacian matrix L, U means an eigen matrix, and U^{T} means a transposed matrix of U. In Equation 6, the eigen matrix U may provide a graph-based Fourier transform specialized for a signal suitable for the corresponding model. For example, the eigen matrix U that satisfies Equation 6 may mean a GBT kernel.

Here, the columns of the eigen matrix U may mean basis vectors of the GBT. When a graph does not have a self-loop, a generalized Laplacian matrix is as represented as Equation 3 above.

An embodiment of the present invention provides a method for generating an optimal transform kernel according to a property of a video signal or a residual signal.

First, an encoder receives a video signal, and generates a prediction error (or residual signal) by subtracting a prediction signal output in a prediction unit from the video signal.

The prediction error is transmitted to a graph-based transform unit, and the graph-based transform unit may generate a graph signal according to a property of the video signal or the prediction error (S1210). The property of the video signal or the prediction error may be presented as boundary information. For example, the boundary information may include at least one of an edge weight, a number of self-loop and a self-loop weight, and various embodiments described above may be applied thereto.

The encoder may determine an optimal transform kernel by using the graph signal (S1220).

As another embodiment of the present invention, an encoder may derive a predefined transform kernel by using the graph signal. In this case, the optimal transform kernel may correspond to one of the preconfigured values, and in this case, an encoder and a decoder may know the preconfigured values, and may store it in a table, for example. In addition, the optimal transform kernel may be defined for each column or row of a target block.

In addition, the encoder may perform a transform for the residual signal using the optimal transform kernel (S1230).

Meanwhile, in an embodiment of the present invention, a transform index that corresponds to the optimal transform kernel may be set (S1240), and the transform index may be encoded and transmitted to a decoder (S1250).

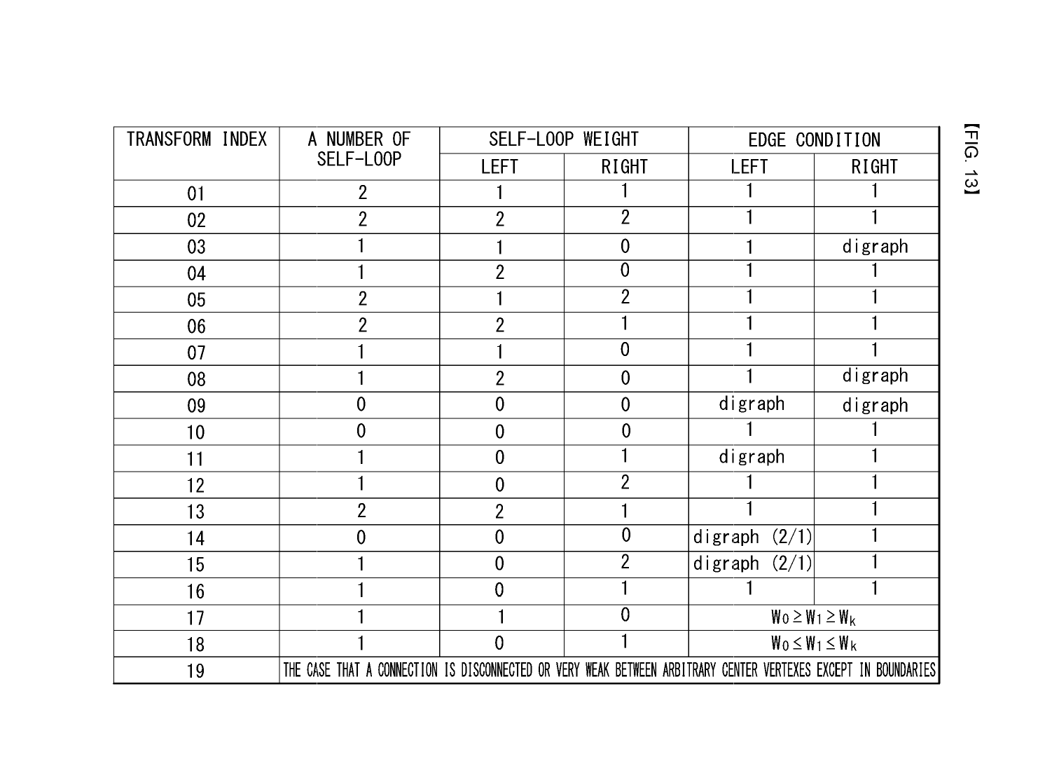

FIG. 13 is a diagram for describing a transform type (or transform index) according to a number of self-loop, a self-loop weight and an edge weight as an embodiment to which the present invention is applied.

According to the present invention, by adjusting at least one of an edge weight, a number of self-loop and a self-loop weight in a boundary point of a block, a Laplacian matrix may be made so as to be proper for an input signal of various properties, and an optimal transform kernel may be generated by using the Laplacian matrix.

Through the link graph to which the present invention is applied, both of Discrete Cosine Transform (DCT) I-VIII kernel and Discrete Sine Transform (DST) I-VIII kernel may be generated, and in addition, a transform kernel proper for a signal that has a connection property may also be generated.

FIG. 13 is a diagram for describing a transform type (or transform index) according to boundary information of a block, and the boundary information may include at least one of a number of self-loop, a self-loop weight and an edge weight.

The number of self-loop represents the number of self-loops, for example, the number of self-loops is one of 0, 1 and 2.

The self-loop weight represents weight strength of a self-loop, and the weight strength may be represented as three values of a strong weight, no weight and a weak weight. For example, the strong weight may be represented as 2, the no weight may be represented as 1, and the weak weight may be represented as 0. However, the present invention is not limited thereto, but the weight value may be represented as at least one value.

The edge weight represents a weight of an edge representing a connection relation between adjacent pixels, and the edge weight may be represented as a value that represents whether there are different weights in a left boundary or a right boundary. For example, in the case that there are different weights in a left boundary or a right boundary, the edge weight may be represented as digraph, and otherwise, it may be represented as 1.

Referring to FIG. 13, transform types of 19 cases are shown, and each of the transform types may be mapped to a transform index. For example, in FIG. 13, it is identified that the boundary information corresponding to transform index ‘01’ has the property that there are two number of self-loops, the self-loop weight does not exist in both of a left side and a right side, and the edge weight does not have different weight in a boundary.

As a particular example, assuming that the property of a video signal or a residual signal may be represented as boundary information that corresponds to the transform index ‘01’, the optimal transform kernel for the video signal or the residual signal may mean the transform kernel mapped to the transform index ‘01’.

Although FIG. 13 shows the transform types for 19 cases, the present invention is not limited thereto, but more transform types may be defined by various combinations of the types of boundary information.

As an embodiment of the present invention, the transform index may be determined based on at least one of a prediction mode and a size of transform unit. For example, the transform index may be constructed with different combinations with each other based on at least one of a prediction mode and a size of transform unit. That is, based on a prediction mode and a size of transform unit, different graph-based transform kernels with each other may be applied.

Hereinafter, the transform types for 19 cases of FIG. 13 above will be described in detail.

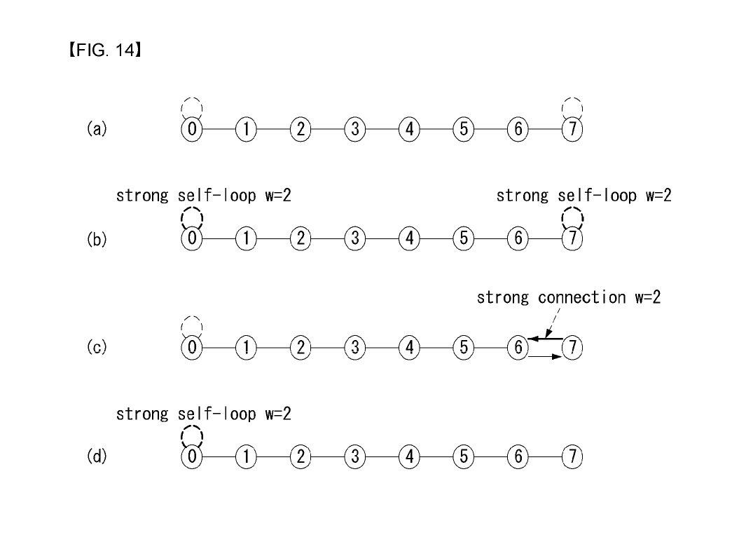

FIGS. 14 to 18 illustrate various examples of line graphs that may be generated based on at least one of a number of self-loop, a self-loop weight and an edge weight as embodiments to which the present invention is applied.

FIG. 14(a) to FIG. 14(d) illustrate a graph signal corresponding to transform indexes ‘01’ to ‘04’, respectively,

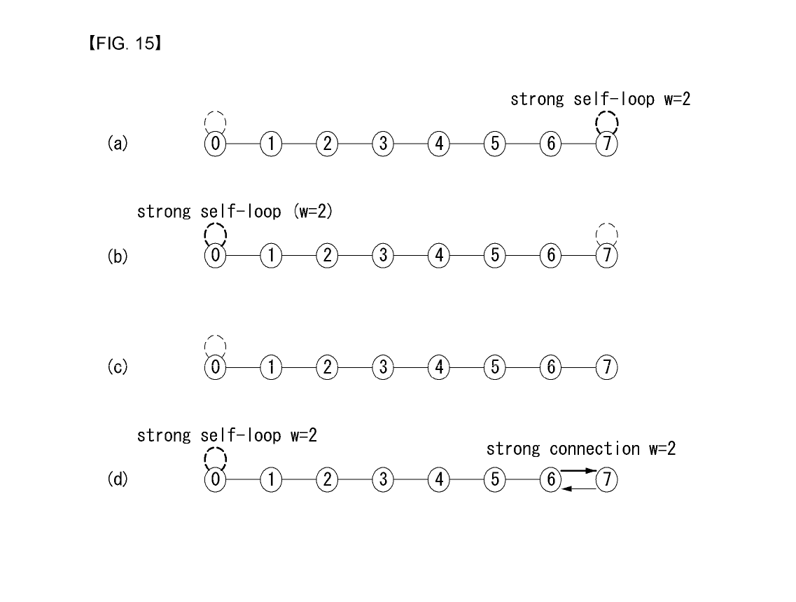

FIG. 15(a) to FIG. 15(d) illustrate a graph signal corresponding to transform indexes ‘05’ to ‘08’, respectively,

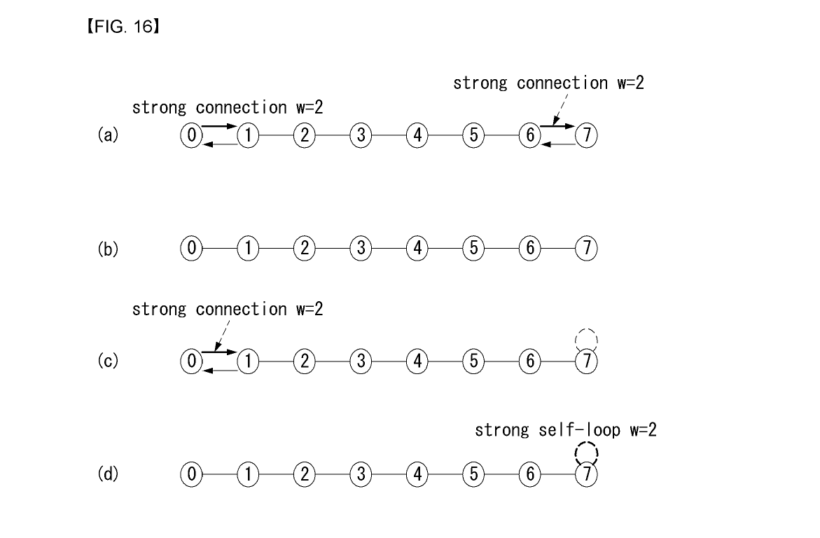

FIG. 16(a) to FIG. 16(d) illustrate a graph signal corresponding to transform indexes ‘09’ to ‘12’, respectively,

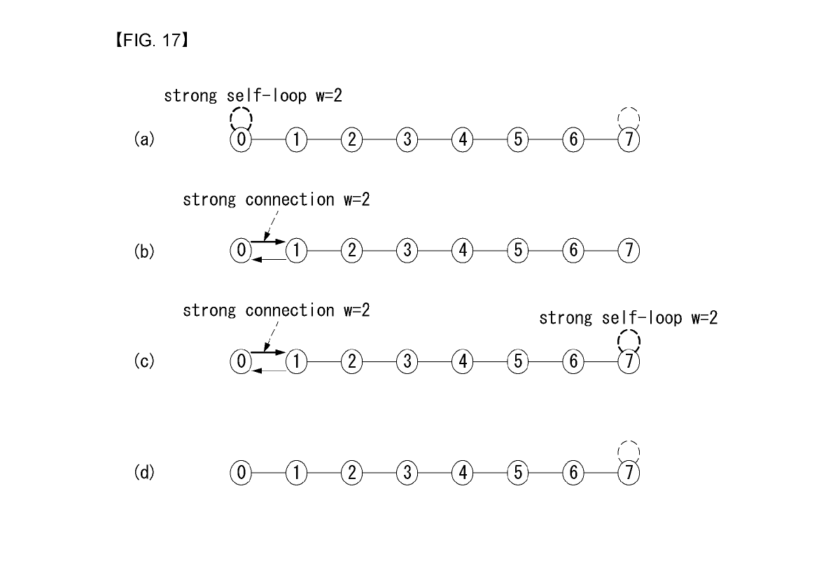

FIG. 17(a) to FIG. 17(d) illustrate a graph signal corresponding to transform indexes ‘13’ to ‘16’, respectively,

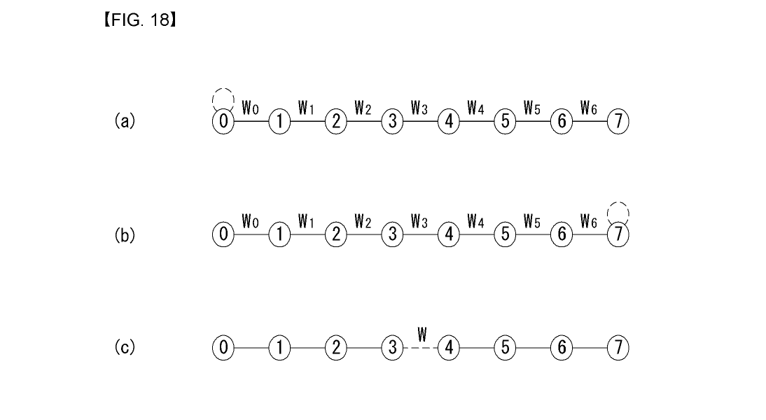

FIG. 18(a) to FIG. 18(c) illustrate a graph signal corresponding to transform indexes ‘17’ to ‘19’, respectively.

(1) Transform Index ‘01’—the Case of Having a Self-Loop in a Left Boundary and a Right Boundary

FIG. 14(a) shows a graph signal that corresponds to transform index ‘01’. It is identified that the boundary information of the graph signal in FIG. 13 has the property that there are two number of self-loops, the self-loop weight does not exist in neither of a left boundary and a right boundary, and the edge weight does not have different weight in a boundary.

In this case, Degree matrix D, Adjacent matrix A and Self-loop matrix S are as represented in Equation 7 below.

$$D = [ \begin{matrix}1 & 0 & 0 & 0 & 0 & 0 & 0 & 0 \\ 0 & 2 & 0 & 0 & 0 & 0 & 0 & 0 \\ 0 & 0 & 2 & 0 & 0 & 0 & 0 & 0 \\ 0 & 0 & 0 & 2 & 0 & 0 & 0 & 0 \\ 0 & 0 & 0 & 0 & 2 & 0 & 0 & 0 \\ 0 & 0 & 0 & 0 & 0 & 2 & 0 & 0 \\ 0 & 0 & 0 & 0 & 0 & 0 & 2 & 0 \\ 0 & 0 & 0 & 0 & 0 & 0 & 0 & 1\end{matrix} ] \\ A = [ \begin{matrix}0 & 1 & 0 & 0 & 0 & 0 & 0 & 0 \\ 1 & 0 & 1 & 0 & 0 & 0 & 0 & 0 \\ 0 & 1 & 0 & 1 & 0 & 0 & 0 & 0 \\ 0 & 0 & 1 & 0 & 1 & 0 & 0 & 0 \\ 0 & 0 & 0 & 1 & 0 & 1 & 0 & 0 \\ 0 & 0 & 0 & 0 & 1 & 0 & 1 & 0 \\ 0 & 0 & 0 & 0 & 0 & 1 & 0 & 1 \\ 0 & 0 & 0 & 0 & 0 & 0 & 1 & 0\end{matrix} ] \\ S = [ \begin{matrix}1 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 1\end{matrix} ] \qquad [ Equation 7 ]$$

Laplacian matrix L obtained according to Equation 5 above is as represented in Equation 8 below.

$$L = D - A + S = [ \begin{matrix}2 & - 1 & 0 & 0 & 0 & 0 & 0 & 0 \\ - 1 & 2 & - 1 & 0 & 0 & 0 & 0 & 0 \\ 0 & - 1 & 2 & - 1 & 0 & 0 & 0 & 0 \\ 0 & 0 & - 1 & 2 & - 1 & 0 & 0 & 0 \\ 0 & 0 & 0 & - 1 & 2 & - 1 & 0 & 0 \\ 0 & 0 & 0 & 0 & - 1 & 2 & - 1 & 0 \\ 0 & 0 & 0 & 0 & 0 & - 1 & 2 & - 1 \\ 0 & 0 & 0 & 0 & 0 & 0 & - 1 & 2\end{matrix} ] \qquad [ Equation 8 ]$$

Furthermore, by using Equation 6 above, a transform kernel that corresponds to the graph signal as shown in FIG. 14(a) above may be obtained.

(2) Transform Index ‘02’—the Case of Having a Self-Loop of a Strong Weight in Both of a Left Boundary and a Right Boundary

FIG. 14(b) shows a graph signal that corresponds to transform index ‘02’. It is identified that the boundary information of the graph signal in FIG. 13 has the property that there are two number of self-loops, the self-loop weight exists in both of a left boundary and a right boundary, and the edge weight does not have different weight in a boundary.

In this case, Degree matrix D, Adjacent matrix A and Self-loop matrix S are as represented in Equation 9 below.

$$D = [ \begin{matrix}1 & 0 & 0 & 0 & 0 & 0 & 0 & 0 \\ 0 & 2 & 0 & 0 & 0 & 0 & 0 & 0 \\ 0 & 0 & 2 & 0 & 0 & 0 & 0 & 0 \\ 0 & 0 & 0 & 2 & 0 & 0 & 0 & 0 \\ 0 & 0 & 0 & 0 & 2 & 0 & 0 & 0 \\ 0 & 0 & 0 & 0 & 0 & 2 & 0 & 0 \\ 0 & 0 & 0 & 0 & 0 & 0 & 2 & 0 \\ 0 & 0 & 0 & 0 & 0 & 0 & 0 & 1\end{matrix} ] \\ A = [ \begin{matrix}0 & 1 & 0 & 0 & 0 & 0 & 0 & 0 \\ 1 & 0 & 1 & 0 & 0 & 0 & 0 & 0 \\ 0 & 1 & 0 & 1 & 0 & 0 & 0 & 0 \\ 0 & 0 & 1 & 0 & 1 & 0 & 0 & 0 \\ 0 & 0 & 0 & 1 & 0 & 1 & 0 & 0 \\ 0 & 0 & 0 & 0 & 1 & 0 & 1 & 0 \\ 0 & 0 & 0 & 0 & 0 & 1 & 0 & 1 \\ 0 & 0 & 0 & 0 & 0 & 0 & 1 & 0\end{matrix} ] \\ S = [ \begin{matrix}2 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 2\end{matrix} ] \qquad [ Equation 9 ]$$

Laplacian matrix L obtained according to Equation 5 above is as represented in Equation 10 below.

$$L = D - A + S = [ \begin{matrix}3 & - 1 & 0 & 0 & 0 & 0 & 0 & 0 \\ - 1 & 2 & - 1 & 0 & 0 & 0 & 0 & 0 \\ 0 & - 1 & 2 & - 1 & 0 & 0 & 0 & 0 \\ 0 & 0 & - 1 & 2 & - 1 & 0 & 0 & 0 \\ 0 & 0 & 0 & - 1 & 2 & - 1 & 0 & 0 \\ 0 & 0 & 0 & 0 & - 1 & 2 & - 1 & 0 \\ 0 & 0 & 0 & 0 & 0 & - 1 & 2 & - 1 \\ 0 & 0 & 0 & 0 & 0 & 0 & - 1 & 3\end{matrix} ] \qquad [ Equation 10 ]$$

Furthermore, by using Equation 6 above, a transform kernel that corresponds to the graph signal as shown in FIG. 14(b) above may be obtained.

(3) Transform Index ‘03’—the Case of Having a Self-Loop in a Left Boundary, and Having a Digraph of which Weight is Different in a Right Boundary

FIG. 14(c) shows a graph signal that corresponds to transform index ‘03’. It is identified that the boundary information of the graph signal in FIG. 13 has the property that there are two number of self-loops, the self-loop weight does not exist in neither of a left boundary and a right boundary, and the edge weight has different weight with each other only in a right boundary.

In this case, Degree matrix D, Adjacent matrix A and Self-loop matrix S are as represented in Equation 11 below.

$$D = [ \begin{matrix}1 & 0 & 0 & 0 & 0 & 0 & 0 & 0 \\ 0 & 2 & 0 & 0 & 0 & 0 & 0 & 0 \\ 0 & 0 & 2 & 0 & 0 & 0 & 0 & 0 \\ 0 & 0 & 0 & 2 & 0 & 0 & 0 & 0 \\ 0 & 0 & 0 & 0 & 2 & 0 & 0 & 0 \\ 0 & 0 & 0 & 0 & 0 & 2 & 0 & 0 \\ 0 & 0 & 0 & 0 & 0 & 0 & 3 & 0 \\ 0 & 0 & 0 & 0 & 0 & 0 & 0 & 2\end{matrix} ] \\ A = [ \begin{matrix}0 & 1 & 0 & 0 & 0 & 0 & 0 & 0 \\ 1 & 0 & 1 & 0 & 0 & 0 & 0 & 0 \\ 0 & 1 & 0 & 1 & 0 & 0 & 0 & 0 \\ 0 & 0 & 1 & 0 & 1 & 0 & 0 & 0 \\ 0 & 0 & 0 & 1 & 0 & 1 & 0 & 0 \\ 0 & 0 & 0 & 0 & 1 & 0 & 1 & 0 \\ 0 & 0 & 0 & 0 & 0 & 1 & 0 & 1 \\ 0 & 0 & 0 & 0 & 0 & 0 & 2 & 0\end{matrix} ] \\ S = [ \begin{matrix}1 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0\end{matrix} ] \qquad [ Equation 11 ]$$

Laplacian matrix L obtained according to Equation 5 above is as represented in Equation 12 below.

$$L = D - A + S = [ \begin{matrix}2 & - 1 & 0 & 0 & 0 & 0 & 0 & 0 \\ - 1 & 2 & - 1 & 0 & 0 & 0 & 0 & 0 \\ 0 & - 1 & 2 & - 1 & 0 & 0 & 0 & 0 \\ 0 & 0 & - 1 & 2 & - 1 & 0 & 0 & 0 \\ 0 & 0 & 0 & - 1 & 2 & - 1 & 0 & 0 \\ 0 & 0 & 0 & 0 & - 1 & 2 & - 1 & 0 \\ 0 & 0 & 0 & 0 & 0 & - 1 & 3 & - 1 \\ 0 & 0 & 0 & 0 & 0 & 0 & - 2 & 2\end{matrix} ] \qquad [ Equation 12 ]$$

Furthermore, by using Equation 6 above, a transform kernel that corresponds to the graph signal as shown in FIG. 14(c) above may be obtained.

(4) Transform Index ‘04’—the Case of Having a Self-Loop of a Strong Weight is Different in a Left Boundary

FIG. 14(d) shows a graph signal that corresponds to transform index ‘04’. It is identified that the boundary information of the graph signal in FIG. 13 has the property that there is one number of self-loop, the self-loop weight exists only in a left boundary and has a strong weight value (2), and the edge weight does not have different weight with each other in a boundary.

In this case, Degree matrix D, Adjacent matrix A and Self-loop matrix S are as represented in Equation 13 below.

$$D = [ \begin{matrix}1 & 0 & 0 & 0 & 0 & 0 & 0 & 0 \\ 0 & 2 & 0 & 0 & 0 & 0 & 0 & 0 \\ 0 & 0 & 2 & 0 & 0 & 0 & 0 & 0 \\ 0 & 0 & 0 & 2 & 0 & 0 & 0 & 0 \\ 0 & 0 & 0 & 0 & 2 & 0 & 0 & 0 \\ 0 & 0 & 0 & 0 & 0 & 2 & 0 & 0 \\ 0 & 0 & 0 & 0 & 0 & 0 & 2 & 0 \\ 0 & 0 & 0 & 0 & 0 & 0 & 0 & 1\end{matrix} ] \\ A = [ \begin{matrix}0 & 1 & 0 & 0 & 0 & 0 & 0 & 0 \\ 1 & 0 & 1 & 0 & 0 & 0 & 0 & 0 \\ 0 & 1 & 0 & 1 & 0 & 0 & 0 & 0 \\ 0 & 0 & 1 & 0 & 1 & 0 & 0 & 0 \\ 0 & 0 & 0 & 1 & 0 & 1 & 0 & 0 \\ 0 & 0 & 0 & 0 & 1 & 0 & 1 & 0 \\ 0 & 0 & 0 & 0 & 0 & 1 & 0 & 1 \\ 0 & 0 & 0 & 0 & 0 & 0 & 1 & 0\end{matrix} ] \\ S = [ \begin{matrix}2 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0\end{matrix} ] \qquad [ Equation 13 ]$$

Laplacian matrix L obtained according to Equation 5 above is as represented in Equation 14 below.

$$L = D - A + S = [ \begin{matrix}3 & - 1 & 0 & 0 & 0 & 0 & 0 & 0 \\ - 1 & 2 & - 1 & 0 & 0 & 0 & 0 & 0 \\ 0 & - 1 & 2 & - 1 & 0 & 0 & 0 & 0 \\ 0 & 0 & - 1 & 2 & - 1 & 0 & 0 & 0 \\ 0 & 0 & 0 & - 1 & 2 & - 1 & 0 & 0 \\ 0 & 0 & 0 & 0 & - 1 & 2 & - 1 & 0 \\ 0 & 0 & 0 & 0 & 0 & - 1 & 2 & - 1 \\ 0 & 0 & 0 & 0 & 0 & 0 & - 1 & 1\end{matrix} ] \qquad [ Equation 14 ]$$

Furthermore, by using Equation 6 above, a transform kernel that corresponds to the graph signal as shown in FIG. 14(d) above may be obtained.

(5) Transform Index ‘05’—the Case of Having a Self-Loop in a Left Boundary, and Having a Self-Loop of a Strong Weight in a Right Boundary

FIG. 15(a) shows a graph signal that corresponds to transform index ‘05’. It is identified that the boundary information of the graph signal in FIG. 13 has the property that there are two number of self-loops, the self-loop weight exists in both of a left boundary and a right boundary, the self-loop weight in a right boundary has a strong weight value (2), and the edge weight does not have different weight with each other in a boundary.

In this case, Degree matrix D, Adjacent matrix A and Self-loop matrix S are as represented in Equation 15 below.

$$D = [ \begin{matrix}1 & 0 & 0 & 0 & 0 & 0 & 0 & 0 \\ 0 & 2 & 0 & 0 & 0 & 0 & 0 & 0 \\ 0 & 0 & 2 & 0 & 0 & 0 & 0 & 0 \\ 0 & 0 & 0 & 2 & 0 & 0 & 0 & 0 \\ 0 & 0 & 0 & 0 & 2 & 0 & 0 & 0 \\ 0 & 0 & 0 & 0 & 0 & 2 & 0 & 0 \\ 0 & 0 & 0 & 0 & 0 & 0 & 2 & 0 \\ 0 & 0 & 0 & 0 & 0 & 0 & 0 & 1\end{matrix} ] \\ A = [ \begin{matrix}0 & 1 & 0 & 0 & 0 & 0 & 0 & 0 \\ 1 & 0 & 1 & 0 & 0 & 0 & 0 & 0 \\ 0 & 1 & 0 & 1 & 0 & 0 & 0 & 0 \\ 0 & 0 & 1 & 0 & 1 & 0 & 0 & 0 \\ 0 & 0 & 0 & 1 & 0 & 1 & 0 & 0 \\ 0 & 0 & 0 & 0 & 1 & 0 & 1 & 0 \\ 0 & 0 & 0 & 0 & 0 & 1 & 0 & 1 \\ 0 & 0 & 0 & 0 & 0 & 0 & 1 & 0\end{matrix} ] \\ S = [ \begin{matrix}1 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 2\end{matrix} ] \qquad [ Equation 15 ]$$

Laplacian matrix L obtained according to Equation 5 above is as represented in Equation 16 below.

$$L = D - A + S = [ \begin{matrix}2 & - 1 & 0 & 0 & 0 & 0 & 0 & 0 \\ - 1 & 2 & - 1 & 0 & 0 & 0 & 0 & 0 \\ 0 & - 1 & 2 & - 1 & 0 & 0 & 0 & 0 \\ 0 & 0 & - 1 & 2 & - 1 & 0 & 0 & 0 \\ 0 & 0 & 0 & - 1 & 2 & - 1 & 0 & 0 \\ 0 & 0 & 0 & 0 & - 1 & 2 & - 1 & 0 \\ 0 & 0 & 0 & 0 & 0 & - 1 & 2 & - 1 \\ 0 & 0 & 0 & 0 & 0 & 0 & - 1 & 3\end{matrix} ] \qquad [ Equation 16 ]$$

Furthermore, by using Equation 6 above, a transform kernel that corresponds to the graph signal as shown in FIG. 15(a) above may be obtained.

(6) Transform Index ‘06’—the Case of Having a Self-Loop of a Strong Weight in a Left Boundary, and Having a Self-Loop in a Right Boundary

FIG. 15(b) shows a graph signal that corresponds to transform index ‘06’. It is identified that the boundary information of the graph signal in FIG. 13 has the property that there are two number of self-loops, the self-loop weight exists in both of a left boundary and a right boundary, the self-loop weight in a left boundary has a strong weight value (2), and the edge weight does not have different weight with each other in a boundary.

In this case, Degree matrix D, Adjacent matrix A and Self-loop matrix S are as represented in Equation 17 below.

$$D = [ \begin{matrix}1 & 0 & 0 & 0 & 0 & 0 & 0 & 0 \\ 0 & 2 & 0 & 0 & 0 & 0 & 0 & 0 \\ 0 & 0 & 2 & 0 & 0 & 0 & 0 & 0 \\ 0 & 0 & 0 & 2 & 0 & 0 & 0 & 0 \\ 0 & 0 & 0 & 0 & 2 & 0 & 0 & 0 \\ 0 & 0 & 0 & 0 & 0 & 2 & 0 & 0 \\ 0 & 0 & 0 & 0 & 0 & 0 & 2 & 0 \\ 0 & 0 & 0 & 0 & 0 & 0 & 0 & 1\end{matrix} ] \\ A = [ \begin{matrix}0 & 1 & 0 & 0 & 0 & 0 & 0 & 0 \\ 1 & 0 & 1 & 0 & 0 & 0 & 0 & 0 \\ 0 & 1 & 0 & 1 & 0 & 0 & 0 & 0 \\ 0 & 0 & 1 & 0 & 1 & 0 & 0 & 0 \\ 0 & 0 & 0 & 1 & 0 & 1 & 0 & 0 \\ 0 & 0 & 0 & 0 & 1 & 0 & 1 & 0 \\ 0 & 0 & 0 & 0 & 0 & 1 & 0 & 1 \\ 0 & 0 & 0 & 0 & 0 & 0 & 1 & 0\end{matrix} ] \\ S = [ \begin{matrix}2 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 1\end{matrix} ] \qquad [ Equation 17 ]$$

Laplacian matrix L obtained according to Equation 5 above is as represented in Equation 18 below.

$$L = D - A + S = [ \begin{matrix}2 & - 1 & 0 & 0 & 0 & 0 & 0 & 0 \\ - 1 & 2 & - 1 & 0 & 0 & 0 & 0 & 0 \\ 0 & - 1 & 2 & - 1 & 0 & 0 & 0 & 0 \\ 0 & 0 & - 1 & 2 & - 1 & 0 & 0 & 0 \\ 0 & 0 & 0 & - 1 & 2 & - 1 & 0 & 0 \\ 0 & 0 & 0 & 0 & - 1 & 2 & - 1 & 0 \\ 0 & 0 & 0 & 0 & 0 & - 1 & 2 & - 1 \\ 0 & 0 & 0 & 0 & 0 & 0 & - 1 & 1\end{matrix} ] \qquad [ Equation 18 ]$$

Furthermore, by using Equation 6 above, a transform kernel that corresponds to the graph signal as shown in FIG. 15(b) above may be obtained.

(7) Transform Index ‘07’—the Case of Having a Self-Loop Only in a Left Boundary

FIG. 15(c) shows a graph signal that corresponds to transform index ‘07’. It is identified that the boundary information of the graph signal in FIG. 13 has the property that there is one number of self-loop, the self-loop weight exists only in a left boundary, and the edge weight does not have different weight with each other in a boundary.

In this case, Degree matrix D, Adjacent matrix A and Self-loop matrix S are as represented in Equation 19 below.

$$\begin{matrix}D = [ \begin{matrix}1 & 0 & 0 & 0 & 0 & 0 & 0 & 0 \\ 0 & 2 & 0 & 0 & 0 & 0 & 0 & 0 \\ 0 & 0 & 2 & 0 & 0 & 0 & 0 & 0 \\ 0 & 0 & 0 & 2 & 0 & 0 & 0 & 0 \\ 0 & 0 & 0 & 0 & 2 & 0 & 0 & 0 \\ 0 & 0 & 0 & 0 & 0 & 2 & 0 & 0 \\ 0 & 0 & 0 & 0 & 0 & 0 & 2 & 0 \\ 0 & 0 & 0 & 0 & 0 & 0 & 0 & 1\end{matrix} ] & [ Equation 19 ] \\ A = [ \begin{matrix}0 & 1 & 0 & 0 & 0 & 0 & 0 & 0 \\ 1 & 0 & 1 & 0 & 0 & 0 & 0 & 0 \\ 0 & 1 & 0 & 1 & 0 & 0 & 0 & 0 \\ 0 & 0 & 1 & 0 & 1 & 0 & 0 & 0 \\ 0 & 0 & 0 & 1 & 0 & 1 & 0 & 0 \\ 0 & 0 & 0 & 0 & 1 & 0 & 1 & 0 \\ 0 & 0 & 0 & 0 & 0 & 1 & 0 & 1 \\ 0 & 0 & 0 & 0 & 0 & 0 & 1 & 0\end{matrix} ] & \\ S = [ \begin{matrix}1 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0\end{matrix} ] & \end{matrix}$$

Laplacian matrix L obtained according to Equation 5 above is as represented in Equation 20 below.

$$L = D - A + S = [ \begin{matrix}2 & - 1 & 0 & 0 & 0 & 0 & 0 & 0 \\ - 1 & 2 & - 1 & 0 & 0 & 0 & 0 & 0 \\ 0 & - 1 & 2 & - 1 & 0 & 0 & 0 & 0 \\ 0 & 0 & - 1 & 2 & - 1 & 0 & 0 & 0 \\ 0 & 0 & 0 & - 1 & 2 & - 1 & 0 & 0 \\ 0 & 0 & 0 & 0 & - 1 & 2 & - 1 & 0 \\ 0 & 0 & 0 & 0 & 0 & - 1 & 2 & - 1 \\ 0 & 0 & 0 & 0 & 0 & 0 & - 1 & 1\end{matrix} ] \qquad [ Equation 20 ]$$

Furthermore, by using Equation 6 above, a transform kernel that corresponds to the graph signal as shown in FIG. 15(c) above may be obtained.

(8) Transform Index ‘08’—the Case of Having a Self-Loop of a Strong Weight in a Left Boundary, and Having a Digraph of which Weight is Different in a Right Boundary

FIG. 15(d) shows a graph signal that corresponds to transform index ‘08’. It is identified that the boundary information of the graph signal in FIG. 13 has the property that there is one number of self-loop, the self-loop weight exists only in a left boundary, the self-loop weight has a strong weight value (2) in a left boundary, and the edge weight has different weight with each other only in a right boundary.

In this case, Degree matrix D, Adjacent matrix A and Self-loop matrix S are as represented in Equation 21 below.

$$\begin{matrix}D = [ \begin{matrix}1 & 0 & 0 & 0 & 0 & 0 & 0 & 0 \\ 0 & 2 & 0 & 0 & 0 & 0 & 0 & 0 \\ 0 & 0 & 2 & 0 & 0 & 0 & 0 & 0 \\ 0 & 0 & 0 & 2 & 0 & 0 & 0 & 0 \\ 0 & 0 & 0 & 0 & 2 & 0 & 0 & 0 \\ 0 & 0 & 0 & 0 & 0 & 2 & 0 & 0 \\ 0 & 0 & 0 & 0 & 0 & 0 & 3 & 0 \\ 0 & 0 & 0 & 0 & 0 & 0 & 0 & 2\end{matrix} ] & [ Equation 21 ] \\ A = [ \begin{matrix}0 & 1 & 0 & 0 & 0 & 0 & 0 & 0 \\ 1 & 0 & 1 & 0 & 0 & 0 & 0 & 0 \\ 0 & 1 & 0 & 1 & 0 & 0 & 0 & 0 \\ 0 & 0 & 1 & 0 & 1 & 0 & 0 & 0 \\ 0 & 0 & 0 & 1 & 0 & 1 & 0 & 0 \\ 0 & 0 & 0 & 0 & 1 & 0 & 1 & 0 \\ 0 & 0 & 0 & 0 & 0 & 1 & 0 & 1 \\ 0 & 0 & 0 & 0 & 0 & 0 & 2 & 0\end{matrix} ] & \\ S = [ \begin{matrix}2 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0\end{matrix} ] & \end{matrix}$$

Laplacian matrix L obtained according to Equation 5 above is as represented in Equation 22 below.

$$L = D - A + S = [ \begin{matrix}3 & - 1 & 0 & 0 & 0 & 0 & 0 & 0 \\ - 1 & 2 & - 1 & 0 & 0 & 0 & 0 & 0 \\ 0 & - 1 & 2 & - 1 & 0 & 0 & 0 & 0 \\ 0 & 0 & - 1 & 2 & - 1 & 0 & 0 & 0 \\ 0 & 0 & 0 & - 1 & 2 & - 1 & 0 & 0 \\ 0 & 0 & 0 & 0 & - 1 & 2 & - 1 & 0 \\ 0 & 0 & 0 & 0 & 0 & - 1 & 2 & - 1 \\ 0 & 0 & 0 & 0 & 0 & 0 & - 2 & 2\end{matrix} ] \qquad [ Equation 22 ]$$

Furthermore, by using Equation 6 above, a transform kernel that corresponds to the graph signal as shown in FIG. 15(d) above may be obtained.

(9) Transform Index ‘09’—the Case of not Having a Self-Loop in Both of a Left Boundary and a Right Boundary, and Having a Digraph of which Weight is Different in Both of a Left Boundary and a Right Boundary

FIG. 16(a) shows a graph signal that corresponds to transform index ‘09’. It is identified that the boundary information of the graph signal in FIG. 13 has the property that the number of self-loop is zero, the self-loop weight does not exist in neither of a left boundary and a right boundary, and the edge weight has different weight with each other in both of a left boundary and a right boundary.

In this case, Degree matrix D, Adjacent matrix A and Self-loop matrix S are as represented in Equation 23 below. Since the self-loop does not exist, it is identified that S=0.

$$\begin{matrix}D = [ \begin{matrix}2 & 0 & 0 & 0 & 0 & 0 & 0 & 0 \\ 0 & 3 & 0 & 0 & 0 & 0 & 0 & 0 \\ 0 & 0 & 2 & 0 & 0 & 0 & 0 & 0 \\ 0 & 0 & 0 & 2 & 0 & 0 & 0 & 0 \\ 0 & 0 & 0 & 0 & 2 & 0 & 0 & 0 \\ 0 & 0 & 0 & 0 & 0 & 2 & 0 & 0 \\ 0 & 0 & 0 & 0 & 0 & 0 & 3 & 0 \\ 0 & 0 & 0 & 0 & 0 & 0 & 0 & 2\end{matrix} ] & [ Equation 23 ] \\ A = [ \begin{matrix}0 & 2 & 0 & 0 & 0 & 0 & 0 & 0 \\ 1 & 0 & 1 & 0 & 0 & 0 & 0 & 0 \\ 0 & 1 & 0 & 1 & 0 & 0 & 0 & 0 \\ 0 & 0 & 1 & 0 & 1 & 0 & 0 & 0 \\ 0 & 0 & 0 & 1 & 0 & 1 & 0 & 0 \\ 0 & 0 & 0 & 0 & 1 & 0 & 1 & 0 \\ 0 & 0 & 0 & 0 & 0 & 1 & 0 & 1 \\ 0 & 0 & 0 & 0 & 0 & 0 & 2 & 0\end{matrix} ] & \end{matrix}$$

Laplacian matrix L obtained according to Equation 5 above is as represented in Equation 24 below.

$$L = D - A = [ \begin{matrix}2 & - 2 & 0 & 0 & 0 & 0 & 0 & 0 \\ - 1 & 2 & - 1 & 0 & 0 & 0 & 0 & 0 \\ 0 & - 1 & 2 & - 1 & 0 & 0 & 0 & 0 \\ 0 & 0 & - 1 & 2 & - 1 & 0 & 0 & 0 \\ 0 & 0 & 0 & - 1 & 2 & - 1 & 0 & 0 \\ 0 & 0 & 0 & 0 & - 1 & 2 & - 1 & 0 \\ 0 & 0 & 0 & 0 & 0 & - 1 & 3 & - 1 \\ 0 & 0 & 0 & 0 & 0 & 0 & - 2 & 2\end{matrix} ] \qquad [ Equation 24 ]$$

Furthermore, by using Equation 6 above, a transform kernel that corresponds to the graph signal as shown in FIG. 16(a) above may be obtained.

(10) Transform Index ‘10’—the Case that a Weight is Regular

FIG. 16(b) shows a graph signal that corresponds to transform index ‘10’. It is identified that the boundary information of the graph signal in FIG. 13 has the property that the number of self-loop is zero, the self-loop weight does not exist in neither of a left boundary and a right boundary, and the edge weight does not have different weight with each other in neither of a left boundary and a right boundary.

That is, it represents that a weight is regular.

In this case, Degree matrix D, Adjacent matrix A and Self-loop matrix S are as represented in Equation 25 below. Since the self-loop does not exist, it is identified that S=0.

$$\begin{matrix}D = [ \begin{matrix}1 & 0 & 0 & 0 & 0 & 0 & 0 & 0 \\ 0 & 2 & 0 & 0 & 0 & 0 & 0 & 0 \\ 0 & 0 & 2 & 0 & 0 & 0 & 0 & 0 \\ 0 & 0 & 0 & 2 & 0 & 0 & 0 & 0 \\ 0 & 0 & 0 & 0 & 2 & 0 & 0 & 0 \\ 0 & 0 & 0 & 0 & 0 & 2 & 0 & 0 \\ 0 & 0 & 0 & 0 & 0 & 0 & 2 & 0 \\ 0 & 0 & 0 & 0 & 0 & 0 & 0 & 1\end{matrix} ] & [ Equation 25 ] \\ A = [ \begin{matrix}0 & 1 & 0 & 0 & 0 & 0 & 0 & 0 \\ 1 & 0 & 1 & 0 & 0 & 0 & 0 & 0 \\ 0 & 1 & 0 & 1 & 0 & 0 & 0 & 0 \\ 0 & 0 & 1 & 0 & 1 & 0 & 0 & 0 \\ 0 & 0 & 0 & 1 & 0 & 1 & 0 & 0 \\ 0 & 0 & 0 & 0 & 1 & 0 & 1 & 0 \\ 0 & 0 & 0 & 0 & 0 & 1 & 0 & 1 \\ 0 & 0 & 0 & 0 & 0 & 0 & 1 & 0\end{matrix} ] & \end{matrix}$$

Laplacian matrix L obtained according to Equation 5 above is as represented in Equation 26 below.

$$L = D - A = [ \begin{matrix}1 & - 1 & 0 & 0 & 0 & 0 & 0 & 0 \\ - 1 & 2 & - 1 & 0 & 0 & 0 & 0 & 0 \\ 0 & - 1 & 2 & - 1 & 0 & 0 & 0 & 0 \\ 0 & 0 & - 1 & 2 & - 1 & 0 & 0 & 0 \\ 0 & 0 & 0 & - 1 & 2 & - 1 & 0 & 0 \\ 0 & 0 & 0 & 0 & - 1 & 2 & - 1 & 0 \\ 0 & 0 & 0 & 0 & 0 & - 1 & 2 & - 1 \\ 0 & 0 & 0 & 0 & 0 & 0 & - 1 & 1\end{matrix} ] \qquad [ Equation 26 ]$$

Furthermore, by using Equation 6 above, a transform kernel that corresponds to the graph signal as shown in FIG. 16(b) above may be obtained.

(11) Transform Index ‘11’—the Case of Having a Self-Loop in a Right Boundary, and Having a Digraph of which Weight is Different in a Left Boundary

FIG. 16(c) shows a graph signal that corresponds to transform index ‘11’. It is identified that the boundary information of the graph signal in FIG. 13 has the property that there is one number of self-loop, the self-loop weight exists only in a right boundary, and the edge weight has different weight with each other only in a left boundary.

In this case, Degree matrix D, Adjacent matrix A and Self-loop matrix S are as represented in Equation 27 below.

$$\begin{matrix}D = [ \begin{matrix}2 & 0 & 0 & 0 & 0 & 0 & 0 & 0 \\ 0 & 3 & 0 & 0 & 0 & 0 & 0 & 0 \\ 0 & 0 & 2 & 0 & 0 & 0 & 0 & 0 \\ 0 & 0 & 0 & 2 & 0 & 0 & 0 & 0 \\ 0 & 0 & 0 & 0 & 2 & 0 & 0 & 0 \\ 0 & 0 & 0 & 0 & 0 & 2 & 0 & 0 \\ 0 & 0 & 0 & 0 & 0 & 0 & 2 & 0 \\ 0 & 0 & 0 & 0 & 0 & 0 & 0 & 1\end{matrix} ] & [ Equation 27 ] \\ A = [ \begin{matrix}0 & 2 & 0 & 0 & 0 & 0 & 0 & 0 \\ 1 & 0 & 1 & 0 & 0 & 0 & 0 & 0 \\ 0 & 1 & 0 & 1 & 0 & 0 & 0 & 0 \\ 0 & 0 & 1 & 0 & 1 & 0 & 0 & 0 \\ 0 & 0 & 0 & 1 & 0 & 1 & 0 & 0 \\ 0 & 0 & 0 & 0 & 1 & 0 & 1 & 0 \\ 0 & 0 & 0 & 0 & 0 & 1 & 0 & 1 \\ 0 & 0 & 0 & 0 & 0 & 0 & 1 & 0\end{matrix} ] & \\ S = [ \begin{matrix}0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 1\end{matrix} ] & \end{matrix}$$

Laplacian matrix L obtained according to Equation 5 above is as represented in Equation 28 below.

$$L = D - A + S = [ \begin{matrix}2 & - 2 & 0 & 0 & 0 & 0 & 0 & 0 \\ - 1 & 3 & - 1 & 0 & 0 & 0 & 0 & 0 \\ 0 & - 1 & 2 & - 1 & 0 & 0 & 0 & 0 \\ 0 & 0 & - 1 & 2 & - 1 & 0 & 0 & 0 \\ 0 & 0 & 0 & - 1 & 2 & - 1 & 0 & 0 \\ 0 & 0 & 0 & 0 & - 1 & 2 & - 1 & 0 \\ 0 & 0 & 0 & 0 & 0 & - 1 & 2 & - 1 \\ 0 & 0 & 0 & 0 & 0 & 0 & - 1 & 2\end{matrix} ] \qquad [ Equation 28 ]$$

Furthermore, by using Equation 6 above, a transform kernel that corresponds to the graph signal as shown in FIG. 16(c) above may be obtained.

(12) Transform Index ‘12’—the Case of Having a Self-Loop of a Strong Weight in a Right Boundary

FIG. 16(d) shows a graph signal that corresponds to transform index ‘12’. It is identified that the boundary information of the graph signal in FIG. 13 has the property that there is one number of self-loop, the self-loop weight exists only in a right boundary and has strong weight value (2), and the edge weight does not have different weight with each other in a boundary.

In this case, Degree matrix D, Adjacent matrix A and Self-loop matrix S are as represented in Equation 29 below.

$$\begin{matrix}D = [ \begin{matrix}1 & 0 & 0 & 0 & 0 & 0 & 0 & 0 \\ 0 & 2 & 0 & 0 & 0 & 0 & 0 & 0 \\ 0 & 0 & 2 & 0 & 0 & 0 & 0 & 0 \\ 0 & 0 & 0 & 2 & 0 & 0 & 0 & 0 \\ 0 & 0 & 0 & 0 & 2 & 0 & 0 & 0 \\ 0 & 0 & 0 & 0 & 0 & 2 & 0 & 0 \\ 0 & 0 & 0 & 0 & 0 & 0 & 2 & 0 \\ 0 & 0 & 0 & 0 & 0 & 0 & 0 & 1\end{matrix} ] & [ Equation 29 ] \\ A = [ \begin{matrix}0 & 1 & 0 & 0 & 0 & 0 & 0 & 0 \\ 1 & 0 & 1 & 0 & 0 & 0 & 0 & 0 \\ 0 & 1 & 0 & 1 & 0 & 0 & 0 & 0 \\ 0 & 0 & 1 & 0 & 1 & 0 & 0 & 0 \\ 0 & 0 & 0 & 1 & 0 & 1 & 0 & 0 \\ 0 & 0 & 0 & 0 & 1 & 0 & 1 & 0 \\ 0 & 0 & 0 & 0 & 0 & 1 & 0 & 1 \\ 0 & 0 & 0 & 0 & 0 & 0 & 1 & 0\end{matrix} ] & \\ S = [ \begin{matrix}0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 2\end{matrix} ] & \end{matrix}$$

Laplacian matrix L obtained according to Equation 5 above is as represented in Equation 30 below.

$$L = D - A + S = [ \begin{matrix}1 & - 1 & 0 & 0 & 0 & 0 & 0 & 0 \\ - 1 & 2 & - 1 & 0 & 0 & 0 & 0 & 0 \\ 0 & - 1 & 2 & - 1 & 0 & 0 & 0 & 0 \\ 0 & 0 & - 1 & 2 & - 1 & 0 & 0 & 0 \\ 0 & 0 & 0 & - 1 & 2 & - 1 & 0 & 0 \\ 0 & 0 & 0 & 0 & - 1 & 2 & - 1 & 0 \\ 0 & 0 & 0 & 0 & 0 & - 1 & 2 & - 1 \\ 0 & 0 & 0 & 0 & 0 & 0 & - 1 & 3\end{matrix} ] \qquad [ Equation 30 ]$$

Furthermore, by using Equation 6 above, a transform kernel that corresponds to the graph signal as shown in FIG. 16(d) above may be obtained.

(13) Transform Index ‘13’—the Case of Having a Self-Loop in Both of a Left Boundary and a Right Boundary, and Having a Strong Weight Only in a Left Boundary

FIG. 17(a) shows a graph signal that corresponds to transform index ‘13’. It is identified that the boundary information of the graph signal in FIG. 13 has the property that there are two number of self-loops, the self-loop weight exists in both of a left boundary and a right boundary, and the edge weight does not have different weight with each other in neither of a left boundary and a right boundary.

In this case, Degree matrix D, Adjacent matrix A and Self-loop matrix S are as represented in Equation 31 below.

$$\begin{matrix}D = [ \begin{matrix}1 & 0 & 0 & 0 & 0 & 0 & 0 & 0 \\ 0 & 2 & 0 & 0 & 0 & 0 & 0 & 0 \\ 0 & 0 & 2 & 0 & 0 & 0 & 0 & 0 \\ 0 & 0 & 0 & 2 & 0 & 0 & 0 & 0 \\ 0 & 0 & 0 & 0 & 2 & 0 & 0 & 0 \\ 0 & 0 & 0 & 0 & 0 & 2 & 0 & 0 \\ 0 & 0 & 0 & 0 & 0 & 0 & 2 & 0 \\ 0 & 0 & 0 & 0 & 0 & 0 & 0 & 1\end{matrix} ] & [ Equation 31 ] \\ A = [ \begin{matrix}0 & 1 & 0 & 0 & 0 & 0 & 0 & 0 \\ 1 & 0 & 1 & 0 & 0 & 0 & 0 & 0 \\ 0 & 1 & 0 & 1 & 0 & 0 & 0 & 0 \\ 0 & 0 & 1 & 0 & 1 & 0 & 0 & 0 \\ 0 & 0 & 0 & 1 & 0 & 1 & 0 & 0 \\ 0 & 0 & 0 & 0 & 1 & 0 & 1 & 0 \\ 0 & 0 & 0 & 0 & 0 & 1 & 0 & 1 \\ 0 & 0 & 0 & 0 & 0 & 0 & 1 & 0\end{matrix} ] & \\ S = [ \begin{matrix}2 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 1\end{matrix} ] & \end{matrix}$$

Laplacian matrix L obtained according to Equation 5 above is as represented in Equation 32 below.

$$L = D - A + S = [ \begin{matrix}3 & - 1 & 0 & 0 & 0 & 0 & 0 & 0 \\ - 1 & 2 & - 1 & 0 & 0 & 0 & 0 & 0 \\ 0 & - 1 & 2 & - 1 & 0 & 0 & 0 & 0 \\ 0 & 0 & - 1 & 2 & - 1 & 0 & 0 & 0 \\ 0 & 0 & 0 & - 1 & 2 & - 1 & 0 & 0 \\ 0 & 0 & 0 & 0 & - 1 & 2 & - 1 & 0 \\ 0 & 0 & 0 & 0 & 0 & - 1 & 2 & - 1 \\ 0 & 0 & 0 & 0 & 0 & 0 & - 1 & 2\end{matrix} ] \qquad [ Equation 32 ]$$

Furthermore, by using Equation 6 above, a transform kernel that corresponds to the graph signal as shown in FIG. 17(a) above may be obtained.

(14) Transform Index ‘14’—the Case of Having a Digraph of which Boundary is Different in a Left Boundary

FIG. 17(b) shows a graph signal that corresponds to transform index ‘14’. It is identified that the boundary information of the graph signal in FIG. 13 has the property that the number of self-loop is zero, the self-loop weight does not exist, and the edge weight has different weight with each other only in a left boundary.

In this case, Degree matrix D, Adjacent matrix A and Self-loop matrix S are as represented in Equation 33 below. Since the self-loop does not exist, it is identified that S=0.

$$D = [ \begin{matrix}2 & 0 & 0 & 0 & 0 & 0 & 0 & 0 \\ 0 & 3 & 0 & 0 & 0 & 0 & 0 & 0 \\ 0 & 0 & 2 & 0 & 0 & 0 & 0 & 0 \\ 0 & 0 & 0 & 2 & 0 & 0 & 0 & 0 \\ 0 & 0 & 0 & 0 & 2 & 0 & 0 & 0 \\ 0 & 0 & 0 & 0 & 0 & 2 & 0 & 0 \\ 0 & 0 & 0 & 0 & 0 & 0 & 2 & 0 \\ 0 & 0 & 0 & 0 & 0 & 0 & 0 & 1\end{matrix} ] A = [ \begin{matrix}0 & 2 & 0 & 0 & 0 & 0 & 0 & 0 \\ 1 & 0 & 1 & 0 & 0 & 0 & 0 & 0 \\ 0 & 1 & 0 & 1 & 0 & 0 & 0 & 0 \\ 0 & 0 & 1 & 0 & 1 & 0 & 0 & 0 \\ 0 & 0 & 0 & 1 & 0 & 1 & 0 & 0 \\ 0 & 0 & 0 & 0 & 1 & 0 & 1 & 0 \\ 0 & 0 & 0 & 0 & 0 & 1 & 0 & 1 \\ 0 & 0 & 0 & 0 & 0 & 0 & 1 & 0\end{matrix} ] \qquad [ Equation 33 ]$$

Laplacian matrix L obtained according to Equation 5 above is as represented in Equation 34 below.

$$L = D - A + S = [ \begin{matrix}2 & - 2 & 0 & 0 & 0 & 0 & 0 & 0 \\ - 1 & 2 & - 1 & 0 & 0 & 0 & 0 & 0 \\ 0 & - 1 & 2 & - 1 & 0 & 0 & 0 & 0 \\ 0 & 0 & - 1 & 2 & - 1 & 0 & 0 & 0 \\ 0 & 0 & 0 & - 1 & 2 & - 1 & 0 & 0 \\ 0 & 0 & 0 & 0 & - 1 & 2 & - 1 & 0 \\ 0 & 0 & 0 & 0 & 0 & - 1 & 2 & - 1 \\ 0 & 0 & 0 & 0 & 0 & 0 & - 1 & 1\end{matrix} ] \qquad [ Equation 34 ]$$

Furthermore, by using Equation 6 above, a transform kernel that corresponds to the graph signal as shown in FIG. 17(b) above may be obtained.

(15) Transform Index ‘15’—the Case of Having a Self-Loop of a Strong Weight Only in a Right Boundary, and Having a Digraph of which Boundary is Different in a Left Boundary

FIG. 17(c) shows a graph signal that corresponds to transform index ‘15’. It is identified that the boundary information of the graph signal in FIG. 13 has the property that there is one number of self-loop, has a self-loop of a strong weight only in a right boundary, and the edge weight has different weight with each other only in a left boundary.

In this case, Degree matrix D, Adjacent matrix A and Self-loop matrix S are as represented in Equation 35 below.

$$D = [ \begin{matrix}2 & 0 & 0 & 0 & 0 & 0 & 0 & 0 \\ 0 & 3 & 0 & 0 & 0 & 0 & 0 & 0 \\ 0 & 0 & 2 & 0 & 0 & 0 & 0 & 0 \\ 0 & 0 & 0 & 2 & 0 & 0 & 0 & 0 \\ 0 & 0 & 0 & 0 & 2 & 0 & 0 & 0 \\ 0 & 0 & 0 & 0 & 0 & 2 & 0 & 0 \\ 0 & 0 & 0 & 0 & 0 & 0 & 2 & 0 \\ 0 & 0 & 0 & 0 & 0 & 0 & 0 & 1\end{matrix} ] A = [ \begin{matrix}0 & 2 & 0 & 0 & 0 & 0 & 0 & 0 \\ 1 & 0 & 1 & 0 & 0 & 0 & 0 & 0 \\ 0 & 1 & 0 & 1 & 0 & 0 & 0 & 0 \\ 0 & 0 & 1 & 0 & 1 & 0 & 0 & 0 \\ 0 & 0 & 0 & 1 & 0 & 1 & 0 & 0 \\ 0 & 0 & 0 & 0 & 1 & 0 & 1 & 0 \\ 0 & 0 & 0 & 0 & 0 & 1 & 0 & 1 \\ 0 & 0 & 0 & 0 & 0 & 0 & 1 & 0\end{matrix} ] S = [ \begin{matrix}0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 2\end{matrix} ] \qquad [ Equation 35 ]$$

Laplacian matrix L obtained according to Equation 5 above is as represented in Equation 36 below.

$$L = D - A + S = [ \begin{matrix}2 & - 2 & 0 & 0 & 0 & 0 & 0 & 0 \\ - 1 & 2 & - 1 & 0 & 0 & 0 & 0 & 0 \\ 0 & - 1 & 2 & - 1 & 0 & 0 & 0 & 0 \\ 0 & 0 & - 1 & 2 & - 1 & 0 & 0 & 0 \\ 0 & 0 & 0 & - 1 & 2 & - 1 & 0 & 0 \\ 0 & 0 & 0 & 0 & - 1 & 2 & - 1 & 0 \\ 0 & 0 & 0 & 0 & 0 & - 1 & 2 & - 1 \\ 0 & 0 & 0 & 0 & 0 & 0 & - 1 & 3\end{matrix} ] \qquad [ Equation 36 ]$$

Furthermore, by using Equation 6 above, a transform kernel that corresponds to the graph signal as shown in FIG. 17(c) above may be obtained.

(16) Transform Index ‘16’—the Case of Having a Self-Loop Only in a Right Boundary

FIG. 17(d) shows a graph signal that corresponds to transform index ‘16’. It is identified that the boundary information of the graph signal in FIG. 13 has the property that there is one number of self-loop, a self-loop exists only in a right boundary, and the edge weight does not have different weight with each other in a boundary.

In this case, Degree matrix D, Adjacent matrix A and Self-loop matrix S are as represented in Equation 37 below.

$$D = [ \begin{matrix}1 & 0 & 0 & 0 & 0 & 0 & 0 & 0 \\ 0 & 2 & 0 & 0 & 0 & 0 & 0 & 0 \\ 0 & 0 & 2 & 0 & 0 & 0 & 0 & 0 \\ 0 & 0 & 0 & 2 & 0 & 0 & 0 & 0 \\ 0 & 0 & 0 & 0 & 2 & 0 & 0 & 0 \\ 0 & 0 & 0 & 0 & 0 & 2 & 0 & 0 \\ 0 & 0 & 0 & 0 & 0 & 0 & 2 & 0 \\ 0 & 0 & 0 & 0 & 0 & 0 & 0 & 1\end{matrix} ] A = [ \begin{matrix}0 & 1 & 0 & 0 & 0 & 0 & 0 & 0 \\ 1 & 0 & 1 & 0 & 0 & 0 & 0 & 0 \\ 0 & 1 & 0 & 1 & 0 & 0 & 0 & 0 \\ 0 & 0 & 1 & 0 & 1 & 0 & 0 & 0 \\ 0 & 0 & 0 & 1 & 0 & 1 & 0 & 0 \\ 0 & 0 & 0 & 0 & 1 & 0 & 1 & 0 \\ 0 & 0 & 0 & 0 & 0 & 1 & 0 & 1 \\ 0 & 0 & 0 & 0 & 0 & 0 & 1 & 0\end{matrix} ] S = [ \begin{matrix}0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 1\end{matrix} ] \qquad [ Equation 37 ]$$

Laplacian matrix L obtained according to Equation 5 above is as represented in Equation 38 below.

$$L = D - A + S = [ \begin{matrix}1 & - 1 & 0 & 0 & 0 & 0 & 0 & 0 \\ - 1 & 2 & - 1 & 0 & 0 & 0 & 0 & 0 \\ 0 & - 1 & 2 & - 1 & 0 & 0 & 0 & 0 \\ 0 & 0 & - 1 & 2 & - 1 & 0 & 0 & 0 \\ 0 & 0 & 0 & - 1 & 2 & - 1 & 0 & 0 \\ 0 & 0 & 0 & 0 & - 1 & 2 & - 1 & 0 \\ 0 & 0 & 0 & 0 & 0 & - 1 & 2 & - 1 \\ 0 & 0 & 0 & 0 & 0 & 0 & - 1 & 2\end{matrix} ] \qquad [ Equation 38 ]$$

Furthermore, by using Equation 6 above, a transform kernel that corresponds to the graph signal as shown in FIG. 17(d) above may be obtained.

(17) Transform Index ‘17’—the Case of Having a Self-Loop Only in a Left Boundary, and that an Edge Weight has Different Weight with Each Other in Each Edge

FIG. 18(a) shows a graph signal that corresponds to transform index ‘17’. It is identified that the boundary information of the graph signal in FIG. 13 has the property that there is one number of self-loop, a self-loop exists only in a left boundary, and the edge weight has different weight with each other in each edge.

In this case, wₖ represents an edge weight that connects each vertex, and can be calculated as represented in Equation 39 below.

wₖ=ρ^{k},0≤ρ≤1 [Equation 39]

Here, ρ means an edge weight between vertexes, which means a correlation coefficient between pixels. This embodiment may be proper for a signal modeling like the case that a correlation coefficient of a residual pixel is decreased as a distance increases from a reference pixel in intra-prediction from a left or upper boundary.

In this case, Degree matrix D, Adjacent matrix A and Self-loop matrix S are as represented in Equation 40 below.

$$[ Equation 40 ]$$

$$D = [ \begin{matrix}1 & 0 & 0 & 0 & 0 & 0 & 0 & 0 \\ 0 & {w}_{0} + {w}_{1} & 0 & 0 & 0 & 0 & 0 & 0 \\ 0 & 0 & {w}_{1} + {w}_{2} & 0 & 0 & 0 & 0 & 0 \\ 0 & 0 & 0 & {w}_{2} + {w}_{3} & 0 & 0 & 0 & 0 \\ 0 & 0 & 0 & 0 & {w}_{3} + {w}_{4} & 0 & 0 & 0 \\ 0 & 0 & 0 & 0 & 0 & {w}_{4} + w5 & 0 & 0 \\ 0 & 0 & 0 & 0 & 0 & 0 & {w}_{5} + {w}_{6} & 0 \\ 0 & 0 & 0 & 0 & 0 & 0 & 0 & {w}_{6}\end{matrix} ]$$

$$A = [ \begin{matrix}0 & {w}_{0} & 0 & 0 & 0 & 0 & 0 & 0 \\ {w}_{0} & 0 & {w}_{1} & 0 & 0 & 0 & 0 & 0 \\ 0 & {w}_{1} & 0 & {w}_{2} & 0 & 0 & 0 & 0 \\ 0 & 0 & {w}_{2} & 0 & {w}_{3} & 0 & 0 & 0 \\ 0 & 0 & 0 & {w}_{3} & 0 & {w}_{4} & 0 & 0 \\ 0 & 0 & 0 & 0 & {w}_{4} & 0 & {w}_{5} & 0 \\ 0 & 0 & 0 & 0 & 0 & {w}_{5} & 0 & {w}_{6} \\ 0 & 0 & 0 & 0 & 0 & 0 & {w}_{6} & 0\end{matrix} ]$$

$$S = [ \begin{matrix}1 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0\end{matrix} ]$$

Laplacian matrix L obtained according to Equation 5 above is as represented in Equation 41 below.

$$[ Equation 41 ]$$

$$L = D - A + S = \\ [ \begin{matrix}1 + {w}_{0} & - {w}_{0} & 0 & 0 & 0 & 0 & 0 & 0 \\ - {w}_{0} & {w}_{0} + {w}_{1} & - {w}_{1} & 0 & 0 & 0 & 0 & 0 \\ 0 & - {w}_{1} & {w}_{1} + {w}_{2} & - {w}_{2} & 0 & 0 & 0 & 0 \\ 0 & 0 & - {w}_{2} & {w}_{2} + {w}_{3} & - {w}_{3} & 0 & 0 & 0 \\ 0 & 0 & 0 & - {w}_{3} & {w}_{3} + {w}_{4} & - {w}_{4} & 0 & 0 \\ 0 & 0 & 0 & 0 & - {w}_{4} & {w}_{4} + {w}_{5} & - {w}_{5} & 0 \\ 0 & 0 & 0 & 0 & 0 & - {w}_{5} & \begin{matrix}{w}_{5} + \\ {w}_{6}\end{matrix} & - {w}_{6} \\ 0 & 0 & 0 & 0 & 0 & 0 & - {w}_{6} & {w}_{6}\end{matrix} ]$$

For example, when w₀=1 and ρ=0.98, Laplacian matrix L is as represented in Equation 42 below.

$$L = D - A + S = [ \begin{matrix}2 & - 1 & 0 & 0 & 0 & 0 & 0 & 0 \\ - 1 & 1.98 & - 0.98 & 0 & 0 & 0 & 0 & 0 \\ 0 & - 0.98 & 1.9404 & - 0.9604 & 0 & 0 & 0 & 0 \\ 0 & 0 & - 0.9604 & 1.9016 & - 0.9411 & 0 & 0 & 0 \\ 0 & 0 & 0 & - 0.9411 & 1.8636 & - 0.9223 & 0 & 0 \\ 0 & 0 & 0 & 0 & - 0.9223 & 1.8263 & - 0.9039 & 0 \\ 0 & 0 & 0 & 0 & 0 & - 0.9039 & 1.7898 & - 0.8858 \\ 0 & 0 & 0 & 0 & 0 & 0 & - 0.8858 & 0.8858\end{matrix} ] \qquad [ Equation 42 ]$$

Furthermore, by using Equation 6 above, a transform kernel that corresponds to the graph signal as shown in FIG. 18(a) above may be obtained.

(18) Transform Index ‘18’—the Case of Having a Self-Loop Only in a Right Boundary, and that an Edge Weight has Different Weight with Each Other in Each Edge

FIG. 18(b) shows a graph signal that corresponds to transform index ‘18’. It is identified that the boundary information of the graph signal in FIG. 13 has the property that there is one number of self-loop, a self-loop exists only in a right boundary, and the edge weight has different weight with each other in each edge.

In this case, wₖ represents an edge weight that connects each vertex, and can be calculated as represented in Equation 43 below.

wₖ=ρ^{6-k},0≤ρ≤1 [Equation 43]

Here, ρ means an edge weight between vertexes, which means a correlation coefficient between pixels.

In this case, Degree matrix D, Adjacent matrix A and Self-loop matrix S are as represented in Equation 44 below.

$$[ Equation 44 ]$$

$$D = \\ [ \begin{matrix}1 & 0 & 0 & 0 & 0 & 0 & 0 & 0 \\ 0 & {w}_{0} + {w}_{1} & 0 & 0 & 0 & 0 & 0 & 0 \\ 0 & 0 & {w}_{1} + {w}_{2} & 0 & 0 & 0 & 0 & 0 \\ 0 & 0 & 0 & {w}_{2} + {w}_{3} & 0 & 0 & 0 & 0 \\ 0 & 0 & 0 & 0 & {w}_{3} + {w}_{4} & 0 & 0 & 0 \\ 0 & 0 & 0 & 0 & 0 & {w}_{4} + {w}_{5} & 0 & 0 \\ 0 & 0 & 0 & 0 & 0 & 0 & {w}_{5} + {w}_{6} & 0 \\ 0 & 0 & 0 & 0 & 0 & 0 & 0 & {w}_{6}\end{matrix} ]$$

$$A = [ \begin{matrix}0 & {w}_{0} & 0 & 0 & 0 & 0 & 0 & 0 \\ {w}_{0} & 0 & {w}_{1} & 0 & 0 & 0 & 0 & 0 \\ 0 & {w}_{1} & 0 & {w}_{2} & 0 & 0 & 0 & 0 \\ 0 & 0 & {w}_{2} & 0 & {w}_{3} & 0 & 0 & 0 \\ 0 & 0 & 0 & {w}_{3} & 0 & {w}_{4} & 0 & 0 \\ 0 & 0 & 0 & 0 & {w}_{4} & 0 & {w}_{5} & 0 \\ 0 & 0 & 0 & 0 & 0 & {w}_{5} & 0 & {w}_{6} \\ 0 & 0 & 0 & 0 & 0 & 0 & {w}_{6} & 0\end{matrix} ]$$

$$S = [ \begin{matrix}0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 1\end{matrix} ]$$

Laplacian matrix L obtained according to Equation 5 above is as represented in Equation 45 below.

$$[ Equation 45 ]$$

$$L = D - A + S = \\ [ \begin{matrix}{w}_{0} & - {w}_{0} & 0 & 0 & 0 & 0 & 0 & 0 \\ - {w}_{0} & {w}_{0} + {w}_{1} & - {w}_{1} & 0 & 0 & 0 & 0 & 0 \\ 0 & - {w}_{1} & {w}_{1} + {w}_{2} & - {w}_{2} & 0 & 0 & 0 & 0 \\ 0 & 0 & - {w}_{2} & {w}_{2} + {w}_{3} & - {w}_{3} & 0 & 0 & 0 \\ 0 & 0 & 0 & - {w}_{3} & {w}_{3} + {w}_{4} & - {w}_{4} & 0 & 0 \\ 0 & 0 & 0 & 0 & - {w}_{4} & {w}_{4} + {w}_{5} & - {w}_{5} & 0 \\ 0 & 0 & 0 & 0 & 0 & - {w}_{5} & \begin{matrix}{w}_{5} + \\ {w}_{6}\end{matrix} & - {w}_{6} \\ 0 & 0 & 0 & 0 & 0 & 0 & - {w}_{6} & 1 + {w}_{6}\end{matrix} ]$$

For example, when w₀=1 and ρ=0.98, Laplacian matrix L is as represented in Equation 46 below.

$$L = D - A + S = [ \begin{matrix}0.8858 & - 8858 & 0 & 0 & 0 & 0 & 0 & 0 \\ - 8858 & 1.7898 & - 0.9039 & 0 & 0 & 0 & 0 & 0 \\ 0 & - 0.9039 & 1.8263 & - 0.9223 & 0 & 0 & 0 & 0 \\ 0 & 0 & - 0.9223 & 1.8636 & - 0.9411 & 0 & 0 & 0 \\ 0 & 0 & 0 & - 0.9411 & 1.9016 & - 0.9604 & 0 & 0 \\ 0 & 0 & 0 & 0 & - 0.9604 & 1.9404 & - 0.98 & 0 \\ 0 & 0 & 0 & 0 & 0 & - 0.98 & 1.98 & - 1 \\ 0 & 0 & 0 & 0 & 0 & 0 & - 1 & 2\end{matrix} ] \qquad [ Equation 46 ]$$

Furthermore, by using Equation 6 above, a transform kernel that corresponds to the graph signal as shown in FIG. 18(b) above may be obtained.

(19) Transform Index ‘19’—the Case that a Connection is Disconnected or Very Weak Between Arbitrary Center Vertexes Except in Boundaries of Opposite Sides

Referring to FIG. 18(c), Degree matrix D and Adjacent matrix A are as represented in Equation 47 below.

$$D = [ \begin{matrix}1 & 0 & 0 & 0 & 0 & 0 & 0 & 0 \\ 0 & 2 & 0 & 0 & 0 & 0 & 0 & 0 \\ 0 & 0 & 2 & 0 & 0 & 0 & 0 & 0 \\ 0 & 0 & 0 & 1 + w & 0 & 0 & 0 & 0 \\ 0 & 0 & 0 & 0 & 1 + w & 0 & 0 & 0 \\ 0 & 0 & 0 & 0 & 0 & 2 & 0 & 0 \\ 0 & 0 & 0 & 0 & 0 & 0 & 2 & 0 \\ 0 & 0 & 0 & 0 & 0 & 0 & 0 & 1\end{matrix} ] A = [ \begin{matrix}0 & 1 & 0 & 0 & 0 & 0 & 0 & 0 \\ 1 & 0 & 1 & 0 & 0 & 0 & 0 & 0 \\ 0 & 1 & 0 & 1 & 0 & 0 & 0 & 0 \\ 0 & 0 & 1 & 0 & w & 0 & 0 & 0 \\ 0 & 0 & 0 & w & 0 & 1 & 0 & 0 \\ 0 & 0 & 0 & 0 & 1 & 0 & 1 & 0 \\ 0 & 0 & 0 & 0 & 0 & 1 & 0 & 1 \\ 0 & 0 & 0 & 0 & 0 & 0 & 1 & 0\end{matrix} ] \qquad [ Equation 47 ]$$

Here, w means an edge weight between vertexes. For example, very small value may be used for w, like w=0 or w≤0.1, which may be proper for a signal modeling like the case that there exists an adjacent pixel in which a correlation between adjacent pixels is very small within an image or a block of a residual signal.

Laplacian matrix L is as represented in Equation 48 below.

$$L = D - A = [ \begin{matrix}1 & - 1 & 0 & 0 & 0 & 0 & 0 & 0 \\ - 1 & 2 & - 1 & 0 & 0 & 0 & 0 & 0 \\ 0 & - 1 & 2 & - 1 & 0 & 0 & 0 & 0 \\ 0 & 0 & - 1 & 1 + w & w & 0 & 0 & 0 \\ 0 & 0 & 0 & w & 1 + w & - 1 & 0 & 0 \\ 0 & 0 & 0 & 0 & - 1 & 2 & - 1 & 0 \\ 0 & 0 & 0 & 0 & 0 & - 1 & 2 & - 1 \\ 0 & 0 & 0 & 0 & 0 & 0 & - 1 & 1\end{matrix} ] \qquad [ Equation 48 ]$$

Through a line graph represented in one-dimension, a separable transform kernel may be generated, which may be applied in horizontal and vertical directions for two-dimensional residual block (N×N). In addition, the transform kernel generated through the graph modeling may be used as an integer transform kernel by approximating into an adjacent integer after a predetermined constant is multiplied. For example, for the case of transform index ‘07’, the transform kernel which is approximated into an integer by multiplying 724 to an eigen matrix derived from Laplacian matrix is as represented in Equation 49 below.

$$[ Equation 49 ]$$

$${T}_{7} = [ \begin{matrix}65 & 127 & 185 & 237 & 280 & 314 & 338 & 350 \\ 185 & 314 & 350 & 280 & 127 & - 65 & - 237 & - 338 \\ 280 & 338 & 127 & - 185 & - 350 & - 237 & 65 & 314 \\ 338 & 185 & - 237 & - 314 & 65 & 350 & 127 & - 280 \\ 350 & - 65 & - 338 & 127 & 314 & - 185 & - 280 & 237 \\ 314 & - 280 & - 65 & 338 & - 237 & - 127 & 350 & - 185 \\ 237 & - 350 & 280 & - 65 & - 185 & 338 & - 314 & 127 \\ 127 & - 237 & 314 & - 350 & 338 & - 280 & 185 & - 65\end{matrix} ]$$

In the embodiments of the present invention, the case shown in FIG. 13 may be considered for a line graph that has total eight vertexes, but the present invention is not limited thereto. For example, it may be extended to a line graph that has 16, 32, 64 or more number of vertexes.

In the embodiments of the present invention, the line graph may be modeled for a prediction residual signal generated through an intra-prediction or an inter-prediction, and the optimal transform kernel may be selected adaptively according to the property of the prediction residual signal and used.

In the embodiments of the present invention, the transform kernel generated through each line graph may be selectively applied to a horizontal direction and a vertical direction using various combinations, and this may be signaled through additional information.

As described above, the embodiments explained in the present invention may be implemented and performed on a processor, a micro-processor, a controller or a chip. For example, functional modules explained in FIG. 1, FIG. 2, FIG. 8, FIG. 9 and FIG. 10 may be implemented and performed on a computer, a processor, a microprocessor, a controller or a chip.

As described above, the decoder and the encoder to which the present invention is applied may be included in a multimedia broadcasting transmission/reception apparatus, a mobile communication terminal, a home cinema video apparatus, a digital cinema video apparatus, a surveillance camera, a video chatting apparatus, a real-time communication apparatus, such as video communication, a mobile streaming apparatus, a storage medium, a camcorder, a VoD service providing apparatus, an Internet streaming service providing apparatus, a three-dimensional 3D video apparatus, a teleconference video apparatus, and a medical video apparatus and may be used to code video signals and data signals.

Furthermore, the decoding/encoding method to which the present invention is applied may be produced in the form of a program that is to be executed by a computer and may be stored in a computer-readable recording medium. Multimedia data having a data structure according to the present invention may also be stored in computer-readable recording media. The computer-readable recording media include all types of storage devices in which data readable by a computer system is stored. The computer-readable recording media may include a BD, a USB, ROM, RAM, CD-ROM, a magnetic tape, a floppy disk, and an optical data storage device, for example. Furthermore, the computer-readable recording media includes media implemented in the form of carrier waves, e.g., transmission through the Internet. Furthermore, a bit stream generated by the encoding method may be stored in a computer-readable recording medium or may be transmitted over wired/wireless communication networks.

### INDUSTRIAL APPLICABILITY

The exemplary embodiments of the present invention have been disclosed for illustrative purposes, and those skilled in the art may improve, change, replace, or add various other embodiments within the technical spirit and scope of the present invention disclosed in the attached claims.

1. A method for decoding a video signal using a graph-based transform, comprising:
receiving, from the video signal, a transform index for a target block;
deriving a graph-based transform kernel corresponding to the transform index, wherein the graph-based transform kernel is determined based on boundary information, which represents a property of a signal for a block boundary; and
decoding the target block based on the graph-based transform kernel.

2. The method of claim 1, wherein the boundary information includes at least one of an edge weight, a number of self-loop and a self-loop weight.

3. The method of claim 2, wherein at least one of the edge weight and the self-loop weight is separately set into a left boundary value and a right boundary value.

4. The method of claim 1, wherein the graph-based transform kernel corresponds to one of predefined transform types according to the boundary information.

5. The method of claim 4, wherein the graph-based transform kernel is derived for each sub-block according to the transform index, and wherein different transform types with each other are applied to at least two or more sub-blocks.

6. The method of claim 1, when the target block is comprised of M or N sub-blocks which are partitioned in a horizontal direction or a vertical direction, wherein the transform index corresponds to each sub-block.

7. The method of claim 1, wherein the graph-based transform kernel is a 2 dimensional separable graph-based transform kernel generated based on a combination of a plurality of one dimensional graph-based transforms.

8. A method for encoding a video signal using a graph-based transform, comprising:
generating a graph signal according to a property of a differential signal;
determining an optimal transform kernel based on the graph signal, wherein the optimal transform kernel is determined based on boundary information, which represents a property of a signal for a block boundary; and
performing a transform for the residual signal using the optimal transform kernel.

9. The method of claim 8, further comprising encoding a transform index corresponding to the optimal transform kernel.

10. The method of claim 9, wherein the optimal transform kernel is derived for each sub-block according to the transform index, and wherein different transform types with each other are applied to at least two or more sub-blocks.

11. The method of claim 8, wherein the boundary information includes at least one of an edge weight, a number of self-loop and a self-loop weight.

12. The method of claim 1, wherein at least one of the edge weight and the self-loop weight is separately set into a left boundary value and a right boundary value.

13. The method of claim 8, wherein the optimal transform kernel corresponds to one of predefined transform types according to the boundary information.

14. An apparatus for decoding a video signal using a graph-based transform, comprising:
a parsing unit for receiving, from the video signal, a transform index for a target block; and
an inverse transform unit for deriving a graph-based transform kernel corresponding to the transform index, and decoding the target block based on the graph-based transform kernel,
wherein the graph-based transform kernel is determined based on boundary information, which represents a property of a signal for a block boundary.

15. An apparatus for encoding a video signal using a graph-based transform, comprising:
a graph signal generation unit for generating a graph signal according to a property of a differential signal;
a transform matrix determination unit for determining an optimal transform kernel based on the graph signal, wherein the optimal transform kernel is determined based on boundary information, which represents a property of a signal for a block boundary; and
a transform performing unit for performing a transform for the residual signal using the optimal transform kernel.
